(19) United States
(12) Patent Application Publication
(10) Pub. No.: US 2015/0293026 A1
(43) Pub. Date: Oct. 15, 2015

(54) Automated system for tissue histomorphometry

(71) Applicants: Dong-Guk Shin, Storrs, CT (US); Seung-Hyun Hong, Storrs, CT (US); David Rowe, West Hartford, CT (US)

(72) Inventors: Dong-Guk Shin, Storrs, CT (US); Seung-Hyun Hong, Storrs, CT (US); David Rowe, West Hartford, CT (US)

(21) Appl. No.: 13/317,334

(22) Filed: Oct. 14, 2011

Related U.S. Application Data
(60) Provisional application No. 61/393,557, filed on Oct. 15, 2010.

(51) Int. Cl. G01N 21/75; G06K 9/00; G06K 9/46; G02B 21/00

(52) U.S. Cl. CPC G01N 21/75; G02B 21/008; G06K 9/00134; G06K 9/4604

(57) ABSTRACT

The present invention relates to a method for tissue histomorphometry and system suitable therefore. More specifically, the present invention relates to a bone histomorphometry system comprising processing, pattern recognition, and morphological processing components.

### CROSS-REFERENCE TO RELATED APPLICATIONS

This application claims the benefit of priority under 35 U.S.C. 119(e) of U.S. Provisional Patent Application Ser. No. 61/393,557 filed: Oct. 15, 2010, which is incorporated herein by reference in its entirety.

### STATEMENT REGARDING GOVERNMENT SPONSORED RESEARCH

This invention was made with government support under Grant No.: DAMD W81KWH07-2-0085 awarded by the United States Department of Defense (DOD). The government has certain rights in the invention.

### FIELD OF THE INVENTION

The present invention relates to a method for tissue histomorphometry and system suitable therefore.

### BACKGROUND INFORMATION

Tissue histomorphometry is a procedure that allows scientists to analyze a biological sample, e.g., a cell or tissue, and by doing so, study the cellular basis of a disease, diagnose and/or monitor the effects of therapeutic intervention (e.g., drug treatment). For example, bone histomorphometry is heavily used in skeletal research to assess the formation and degradation of bone structure in response to, e.g., a genetic mutation, drug effect or a skeletal repair process employing new biomaterials or stem cells. Central to the evaluation is the preservation of the matrix component of the cell/tissue as well as the cellular elements that modulate cell/tissue function.

The key step in histomorphometry is to quantify desired parameters in tissue sections. The typical approach is to prepare tissue samples, then section, stain and image the prepared samples, and finally examine the images with a microscope equipped with image analysis software. The objective is to assess structural basis and regulatory mechanisms that might lead to understanding of pathologies following the prescribed treatments of the samples.

Traditionally, the quantification histomorphometric parameters is done manually by a technician who invests many hours visually inspecting the stained samples and tracing regions by hand using drawing software under the microscope. Numerous cost issues and quality control issues exist due to the labor intensiveness of the process. Nonetheless, this manual processing has been the norm for the past 20 years. To enhance the precision and reproducibility of an evaluation, it is necessary to take a large number of measurement sites of, for example, 50 fields of sight, to obtain the evaluation results for the respective sites and obtain an average value thereof.

Currently, semi-automated histomorphometry systems, such as OsteoMeasure™ and BioQuant™, are being used to quantify dynamic histology. The general practices have been that a technician performs quantification by manually selecting ROI, distinguishing and marking single labels and multiple labels using a mouse. After the technician traces the desired portion, using input devices, the system calculates the static and dynamic parameter measurements. In this sequence of processes, the marking and tracing are totally dependent on the subjective abilities of the particular technician, and consequently, the achieved results are inconsistent both between samples analyzed by the same technician as well as between different technicians. Therefore, the overall assessment is prone to subjective quantifications.

Another typical problem arises because all of the traces are performed one by one, and the process is performed in a dark room and, therefore, it is very time consuming. For example, the current technology requires that the tissue, e.g., bone, is embedded in a dense plastic block and cut with a powerful microtome. While the quality of the resulting section is excellent, the process takes about 4 weeks to accomplish. In addition, the background autofluoresence is high and the cellular activities used to produce cell specific stains are often leached out. Moreover, because the steps are performed by technicians with varying interpretation biases, it is also hard, if not impossible, to interrelate the information into a coherent interpretation of the histology, not to mention gathering and formatting related histomorphomentry data into a cohesive database amenable to flexible querying. In addition to lack of evaluation standards, due to the labor, time and cost intensive nature of these procedures, most investigators employ only certain aspects of the process or avoid it all together, which compromises the quality of their work. For pharmaceutical companies that need this information for their preclinical FDA applications, a significant cost is incurred and the ability to more routinely use the method for drug development is blunted.

Thus, there is a need in the field for systems and methods that allow for the rapid, yet comprehensive, and automated histomorphometry processing, which overcomes one or more of the deficiencies as described above.

### SUMMARY

Presently described are methods and systems for performing rapid, automated, and economical tissue histology or histomorphometry. The described methods for performing histomorphometry can be applied to any biological sample, e.g., a cell or tissue, including, for example, epithelial, including mesothelia and endothelia; muscle, including smooth, skeletal, and cardiac; connective, including supporting, dense and loose, e.g., bone; nerve, including neurons and glia; and blood, including red blood cells, white blood cells, and platelets; and further including all subtypes.

In one aspect, the description provides methods to cut and image tissue, e.g., non-decalcified bone and teeth, which preserves the quality of the tissue structure and enables the detection of fluorescence based signals without significant background noise, wherein the method is adapted to provide for the application of a large number of sensitive fluorescence based assays.

In another aspect, the description provides a method for performing tissue histomorphometry comprising the steps of providing a biological sample, e.g., cell or tissue, to be analyzed; using a transfer media that does not have an autofluoresence background, e.g., a tape transfer media, that will not compromise the sensitivity of the histology; attaching the non-specimen side of the transfer media to a standard slide using a non-fluoresent adhesive. In certain embodiments, the method may include a step of attaching multiple sections per slide (e.g., up to 12) so that all specimens from an experiment are contained on two slides and are treated equally (from staining to imaging). The method further includes the steps of providing a computer controlled fluorescence microscope, and at least one of a computer implemented display, a storage device, and/or a processor; and defining a region of interest (ROI) within each section on the slide, wherein a series of tiled images from each ROI is created as an automatic imaging routine. An image of the biological specimen is generated, digitized, and stored. The images may be superimposed or viewed as adjacent images. In certain embodiments, the imaging data may be stored on the storage device in communication with a processor or a computer readable medium, e.g., for storage, processing, querying, accessing, retrieving, displaying, analyzing, comparing, or combination thereof, and/or other functionality. In additional embodiments, the method may include additional steps of retrieving the stored imaging data and/or comparing the image data of two or more images, and determining an agent's effect, diagnosing a disease or condition, and/or monitoring the pathological state of a tissue.

In certain embodiments, the tissue imaged in the methods described herein may be a connective tissue. The described methods are suitable for use in situations that are currently not possible, e.g., with non-decalcified bone. Therefore, in another embodiment the connective tissue is bone.

In additional aspects, any of the described methods may further comprise one or more steps of removing the slide set from the microscope, performing one or more staining protocols, and reinserting the slide and reimaging the same ROI. In still additional embodiments the staining protocol is at least one of, e.g., endogenous signals, in vivo and/or in situ immuno-fluorescent signals, enzymatic staining for endogenous cellular activity, or structures, colormetric staining for traditional cellular imaging as described herein, or combinations thereof.

In another aspect, any of the methods described herein may further include a step of assembling the overlaid images for analysis.

In an additional aspect, the description provides methods of performing bone histomorphometry, the methods being as described herein.

In an additional aspect, the description provides a database and/or plurality of databases comprising tissue histomorphometry image data acquired according to the methods provided herein. Unless expressly indicated otherwise, the term “database” is used in an inclusive sense to refer to one or more databases. In an embodiment, the database comprises tissue histomorphometry image data taken from a plurality of tissues, and/or a plurality of organisms, and/or under a plurality of conditions, including normal; pathological or disease state; before, during, and/or after therapeutic treatment, and the like (i.e., “reference signature(s)”), derived using the methods provided herein. In additional embodiments, the database is comprised or stored on a storage device.

In another aspect, the description provides a computer readable medium storing a program causing a computer to execute a process comprising at least one of inputting, storing, processing, querying, accessing, retrieving, displaying, analyzing, comparing, or combination thereof, and/or other functionality, of the histomorphometry image data acquired or input to the database according to the methods provided by the invention. In any of the embodiments described herein, the process can be adapted to execute a process allowing at least one of processing, querying, accessing, retrieving, displaying, analyzing, comparing or combination thereof, of histomorphometry image data stored in the database, and/or of real time image data.

In an additional aspect, the description provides a computer implemented histomorphometry system comprising a microscope and a storage device, wherein the microscope is in communication with the storage device such that histomorphometry image data acquired from a region of interest (ROI) of a tissue is stored to the storage device; and a processor in communication with at least one of the storage device, the microscope or both, wherein the processor is configured to use model-based pattern recognition and/or morphological processing sufficient to process the acquired image data from the ROI. In certain embodiments, the system also comprises a histomorphometry image data database as described herein. In certain embodiments, the system also comprises a computer readable medium storing a program causing a computer to execute a process comprising at least one of inputting, storing, processing, querying, accessing, retrieving, displaying, analyzing, comparing, or combination thereof, and/or other functionality, of the histomorphometry image data acquired or input to the database according to the methods provided by the invention. In an additional embodiment, the system comprises a computer controlled microscope, e.g., a fluorescence, laser scanning or electron microscope, for acquiring and inputting histomorphometric image data.

In an additional aspect, the description provides methods of using the histomorphometry system as described herein, for screening of agents for potential pharmacologic activity, identifying potential new therapeutics, diagnosing and/or monitoring the pathological state of a tissue. In an embodiment, the method comprises the steps of providing the histomorphometry system as described herein comprising a database having one or more reference signatures, and histomorphometric image data of a tissue derived using the methods provided herein, which is to be assayed or queried (i.e., “test signature(s)”). In certain embodiments, the test signature may result from, e.g., the treatment of a tissue or subject with a known or unknown agent; from a subject suffering from a pathological disease or condition; or from an untreated or normal tissue or subject. Thus, the method includes a step of acquiring a test signature according to the methods described herein, querying the database with one or more test signatures; retrieving one or more stored reference signatures; and measuring or analyzing, quantitatively and/or qualitatively, a region of interest within at least one of the reference signatures and at least one of the test signatures, wherein the resulting histomorphometry image data comparison allows for the determination of the pharmacologic activity of an unknown agent, the diagnosis of a disease or condition, and/or the monitoring of a pathological state of a tissue or cell.

In any of embodiments of the computer implemented system or methods as described herein, the system can further be adapted to allow wireless communication allowing multiple users at other computer terminals to perform at least one of histomorphometry image data inputting, storing, processing, querying, accessing, retrieving, displaying, analyzing, and/or comparing the histomorphometry image data acquired.

The present invention further provides any invention described herein.

The preceding general areas of utility are given by way of example only and are not intended to be limiting on the scope of the present disclosure and appended claims. Additional objects and advantages associated with the compositions, methods, and processes of the present invention will be appreciated by one of ordinary skill in the art in light of the instant claims, description, and examples. For example, the various aspects and embodiments of the invention may be utilized in numerous combinations, all of which are expressly contemplated by the present description. These additional advantages objects and embodiments are expressly included within the scope of the present invention. The publications and other materials used herein to illuminate the background of the invention, and in particular cases, to provide additional details respecting the practice, are incorporated by reference, and for convenience are listed in the appended bibliography.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating an embodiment of the invention and are not to be construed as limiting the invention. Further objects, features and advantages of the invention will become apparent from the following detailed description taken in conjunction with the accompanying figures showing illustrative embodiments of the invention, in which:

FIG. 1. Distal femur section illustrating the dark field relief for mineralized bone containing the green and red fluorescent mineralization dyes given at a 1 and 7 day interval.

FIG. 2. (A) Illustration of the stage 1 (endogenous) and 2 (enzymatic) fluorescent signals from the same section of bone. (B) Examples of the colormetric stains that provide traditional orientation of the tissue components of a bone section.

FIG. 3. Registration of multiple images of the same slide. The vertical lines illustrate how the beads interrelate the images.

FIG. 4. Demonstrates an exemplary step of placing multiple sections on the same slide. Use of the binocular dissecting scope (A) allows the technician to obtain the desired section without a trial and error stage. Examples of multiple distal femur sections and calvarial defect sections are shown below the cryostat image. (B) Series of step used by the “mark and find” feature of the microscope that identifies the ROI of each bone and subsequently acquires a tiled image of each ROI without user intervention.

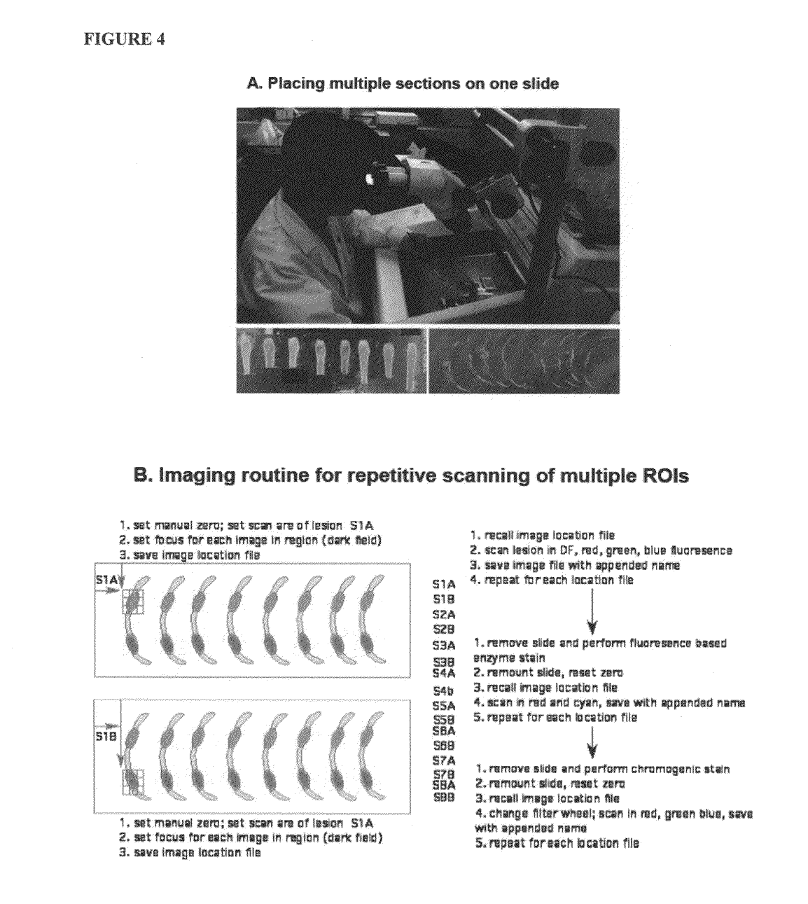

FIG. 5. Estimates for overall processing/imaging time and actual technician effort-time necessary to process a sample from one step to the next.

FIG. 6. Assembling microscopic mosaic images using non-linear correlation technique: (a) assembled VK image, and (b) assembled signal image.

FIG. 7. (a) Label/GFP marked osteoblast image. (b) projected label/GFP marked osteoblast image. Labels and cells are projected on the bone surface.

FIG. 8. (a) Overlaid image and rough ROI. (b) Automatically selected ROI.

FIG. 9. Comparison between manual and automated histomorphometry. (a) DIC image with two labels (red and green) and GFP; (b) snap shot of semi-automated analysis; (c) segmented DIC image with labels and GFP in automated process.

FIG. 10. Examples of analyzed femurs. Top row is for C57BL/6 mouse #2, bottom row is for C3H mouse #1. (a), (e) DIC images; (b), (1) labeled image with adaptively selected ROI; (c), (g) segmented trabeculae with labels. Pink and cyan represent alzarine red 7 and calcein, respectively.

FIG. 11. Day 14 fracture callus from a Col3.6blue/hOCgreen double transgenic mouse. The low power image is a 5× scan of the entire section under DIC to appreciate the mineralized bone and of a region of interest after ELF97 staining for TRAP (yellow) and hematoxylin staining (red). B and C show the individual views of each exposure and the overlay from an area of active woven bone formation (B) and the beginnings of lamellar bone formation (C). Higher magnification of the overlayed image shown in the bottom two images. The underlying cellular detail projects through the fluorescent signals to give better context to appreciate the cellular relationships.

FIG. 12. Lineage trace of SP7 cre in the TM condyle. A. SP7-eGFP expression in the mandibular condylar cartilage. B. Lineage of Sp-7 cells in the mandibular condylar cartilage by breeding a tetracycline off Sp-7 cre recombinase X Cre reporter (TD tomato (red)). A similar relationship is seen in the osteoblast of the underlying trabecular bone. Presumably the stronger expression of both reporter relates to their higher level of expression. However, even within the articular cartilage, there is sufficient SP7-GFPCre activity to mark where the reporter is first observed and how the progeny of these cells progress to become hypertrophic chondrocytes.

FIG. 13. (A and B) Exemplary embodiments of histomorphometry imaging data system as described herein.

FIG. 14. Exemplary overview of an embodiment of the system provided by the invention.

FIG. 15. Overview of an exemplary automated image quantification component of an exemplary system provided by the invention.

FIG. 16. (A) Pseudo colored fraction of selected ROI region. (B) Straight forward region to analyze (a); problematic regions to analyze (b)-(e).

### DETAILED DESCRIPTION

The following is a detailed description of the invention provided to aid those skilled in the art in practicing the present invention. Those of ordinary skill in the art may make modifications and variations in the embodiments described herein without departing from the spirit or scope of the present invention. Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. All publications, patent applications, patents, figures and other references mentioned herein are expressly incorporated by reference in their entirety.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges which may independently be included in the smaller ranges is also encompassed within the invention, subject to any specifically excluded limit in the stated range. Where the stated range includes one or both of the limits, ranges excluding either both of those included limits are also included in the invention.

Although any methods and materials similar or equivalent to those described herein can also be used in the practice or testing of the present invention, the preferred methods and materials are now described. All publications mentioned herein are incorporated herein by reference to disclose and described the methods and/or materials in connection with which the publications are cited.

### 1. DEFINITIONS

It must be noted that as used herein and in the appended claims, the singular forms “a”, “and”, and “the” include plural references unless the context clearly dictates otherwise. All technical and scientific terms used herein have the same meaning.

In order that the present invention may be more readily understood, certain terms are first defined.

As used herein, “histology” or “histomorphmetry” is used generally to refer to the quantitative study of the microscopic organization and structure of a biological sample, e.g., a cell or tissue (e.g., bone), e.g., through the computer-assisted analysis of images formed by a microscope as taught and described herein.

As used herein, the term “tissue” is used in a broad sense and, unless the specification indicates otherwise, can mean any biological sample suitable for study according to the methods described herein, including a cell, a tissue or an organ.

As used herein, the term “computer” can mean, but is in no way limited to, any processor-based or microprocessor-based system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer system executes a set of instructions that are stored in one or more storage elements, in order to process input data. The “storage device” or “storage elements” may also hold data or other information as desired or needed. The storage device may be in the form of an information source or a physical memory element within the processing machine. A storage device or storage element may comprise one or more databases. As used herein a “database” may refer to one or more related or unrelated databases that may store data and/or other information in any form. In some embodiments, data and/or other information may be stored in raw, excerpted, summarized and/or analyzed form.

The set of instructions may include various commands that instruct the processing machine to perform specific operations such as the processes of the various embodiments of the present invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and can mean, but is in no way limited to, any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

Unless defined otherwise, all technical and scientific terms used herein have the meaning commonly understood by a person skilled in the art to which this invention belongs. The following references, the entire disclosures of which are incorporated herein by reference, provide one of skill with a general definition of many of the terms used in this invention: Singleton et al., Dictionary of Microbiology and Molecular Biology (2^{nd} ed. 1994); The Cambridge Dictionary of Science and Technology (Walker ed., 1988); The Glossary of Genetics, 5th Ed., R. Rieger et al. (eds.), Springer Verlag (1991); and Hale & Marham, the Harper Collins Dictionary of Biology (1991). As used herein, the following terms may have meanings ascribed to them below, unless specified otherwise. However, it should be understood that other meanings that are known or understood by those having ordinary skill in the art are also possible, and within the scope of the present invention. All publications, patent applications, patents, and other references mentioned herein are incorporated by reference in their entirety. In the case of conflict, the present specification, including definitions, will control. In addition, the materials, methods, and examples are illustrative only and not intended to be limiting.

Presently described are methods and systems for performing rapid, automated, and economical tissue histology or histomorphometry. The present description provides methods and systems for quantifying histomorphometry image data, which is superior to previous image processing methodologies. The described systems and methods for performing histomorphometry can be applied to any tissue, including, for example, epithelial, including mesothelia and endothelia; muscle, including smooth, skeletal, and cardiac; connective, including supporting, dense and loose, e.g., bone; nerve, including neurons and glia; and blood, including red blood cells, white blood cells, and platelets; and further including all subtypes.

In one aspect, the description provides methods to cut and image tissue suitable for use in histomorphometry imaging, which preserves the quality of the tissue structure and enables the detection of fluorescence based signals without significant background noise, wherein the method is adapted to provide for the application of a large number of sensitive fluorescence based assays.

In an embodiment of this aspect the method comprises the steps of attaching a tissue sample to a transfer media, e.g., a transfer media that does not have an autofluoresence background, e.g., a tape transfer media, that will not compromise the sensitivity of the histology; apposing the non-specimen side of the transfer media to the non-specimen side of a standard slide. In a preferred embodiment, the transfer media comprising the specimen is attached to the slide using a non-fluoresent adhesive. In certain embodiments, the methods may include a step of attaching multiple sections per slide (e.g., up to 12) so that all specimens from an experiment are contained on two slides and are treated equally (from staining to imaging). The method further includes the steps of providing a computer controlled fluorescence microscope, and at least one of a computer implemented display, a storage device, and/or a processor; and defining a region of interest (ROI) within each section on the slide using the microscope, wherein a series of tiled images from each ROI is created as an automatic imaging routine. In certain embodiments, the method includes a step wherein the processor or computer readable medium stores a program causing a computer to execute an automatic imaging routine program. In any of the embodiments described herein, the histomorphometry imaging data is stored on the storage device.

In any of the embodiments described herein, the storage device may be in communication with the processor or computer readable medium comprising program causing a computer to execute a process comprising at least one of storage, processing, querying, accessing, retrieving, displaying, analyzing, comparing, or combination thereof, of the histomorphometry image data.

In additional embodiments, the method may include additional steps of retrieving the stored imaging data and/or comparing the image data of two or more images, and determining an agent's effect, diagnose a disease or condition, and/or monitor the pathological state of a tissue. Such steps can be readily achieved via a computer readable medium comprising a program for executing the respective functions.

In certain embodiments, the tissue imaged in the methods described herein may be a connective tissue. The described methods are suitable for use in situations that are currently not possible, e.g., with non-decalcified bone. Therefore, in another embodiment the connective tissue is bone.

Any of the described methods may further comprise one or more steps of removing the slide set from the microscope, performing one or more staining protocols, and reinserting the slide and reimaging the same ROI. In still additional embodiments the staining protocol is at least one of, e.g., endogenous signals, in vivo and/or in situ immuno-fluorescent signals, enzymatic staining for endogenous cellular activity, or structures, colormetric staining for traditional cellular imaging as described herein, or combinations thereof.

Exemplary staining protocols can include at least one of a chemical stain, an immuno- or antibody label, a fluorescent label, a metabolic indicator, a nucleic acid label, a peptide label, or a combination thereof. A biological specimen is stained and counterstained for a specific marker or in the instance of immunohistochemistry or in situ hybridization, the marker is detectably labeled. Such labels include enzyme, radioisotopes, fluorescence or other labels well known in the art. The sample is then imaged one or more times at a desired region of interest by a photoimaging system to acquire an image. Additional examples of potential stains and methods for use in connection with the systems and methods described herein are provided below.

Nuclear Stains, Intercalating Dyes and Counterstains. The term “nuclear stain” refers to a cytochemical stain that preferentially stains the nuclei of eukaryotic cells. Many nuclear stains are intercalating dyes. The term “intercalating dye” refers to a chemical compound that can insert itself in between adjacent nucleotides of a nucleic acid to provide a detectable color.

Many nuclear stains are known in the art, with one of the most commonly used being hematoxylin. Hematoxylin is often used in combination with various metallic salts (mordants). Hematoxylin stains are used for different staining purposes, and have a variety of colors, depending on the metal used. Aluminum lakes are purple to blue, depending on pH. Iron lakes are blue-black. Chromium lakes are blue-black. Copper lakes are blue-green to purple. Nickel lakes are various shades of violet. Tin lakes are red. Lead lakes are dark brown. Osmium lakes are greenish brown. Other nuclear stains include Giemsa stain, methyl green (which binds to AT-rich DNA regions), and Nuclear Fast-Red.

Fluorescent stains include Hoechst 33342; Hoechst 33258 (Calbiochem), a bisbenzimide DNA intercalator that excites in the near UV (350 nm) and emits in the blue region (450 nm); thiazole orange, a fluorogenic stain for DNA that excites in the blue region (515 nm) and emits in the green region (530 nm) of the visible spectrum; DAPI; ethidium bromide; propidium iodide; TOTO; YOYO-1; and SYTOX Blue or Green stains are also encompassed by the current invention. Several dyes either bind GC-rich or AT-rich chromosomal regions preferentially or show differences in fluorescence intensity upon binding those regions, yielding fluorescent banding patterns. For example, 7-Aminoactinomycin D binds selectively to GC-rich DNA regions and 9-Amino-6-chloro-2-methoxyacridine fluoresces with greatest intensity in AT-rich DNA regions. Acridine homodimer fluoresces preferentially when bound to AT-rich DNA regions.

The term “counterstain,” when used in combination with nuclear stains, refers to cytochemical stains that bind to a region of a eukaryotic cell other than the nucleus. Many counterstains are known in the art. One of the most common is eosin, which stains eukaryotic cell cytoplasm to varying shades of pink. Other counterstains are specific for a particular organelle or a protein in a cell. For example, the Kleihauer-Betke cytochemical stain is specific for hemoglobin F, a hemoglobin type preferentially expressed in fetal cells and therefore can be defined as a specific marker of fetal red blood cells. The term “coordinate” or “address” is used to mean a particular location on a slide or sample. The coordinate or address can be identified by any number of means including, for example, X-Y coordinates, r-P coordinates, and others recognized by those skilled in the art.

In one embodiment, an automated cellular imaging method is used to identify fetal nucleated red blood cells in a maternal blood specimen. Fetal cells are first identified following the Kleihauer-Betke cytochemical stain for hemoglobin F. Fetal cells are identified by the automated cellular imaging system as objects on the basis of their bright red color (indicative of Hemoglobin F) as compared to maternal red blood cells. To assure that appropriate objects are identified, size and shape morphological “filters” are used to exclude very small and very large objects.

Cells are counterstained with an additional cytochemical stain for nucleic acids, resulting in a blue color for nucleated red blood cells (generally, fetal red blood cells). An automated image analysis system identifies blue objects of the appropriate size and shape for an erythrocyte nucleus among the bright red objects, allowing the imaging system to identify and enumerate nucleated fetal red cells. Such cells can be enumerated, allowing for a screen for Down's syndrome in the fetus, wherein the frequency of such cells is typically higher in Down's syndrome pregnancies compared with normal pregnancies.

The results of the H/E staining provide cells with nuclei stained blue-black, cytoplasm stained varying shades of pink; muscle fibers stained deep pinky red; fibrin stained deep pink; and red blood cells stained orange-red. For example, hematoxylin/eosin (H/E) slides are prepared with a standard H/E protocol. Standard solutions include the following: (1) Gills hematoxylin (hematoxylin 6.0 g; aluminum sulphate 4.2 g; citric acid 1.4 g; sodium iodate 0.6 g; ethylene glycol 269 ml; distilled water 680 ml); (2) eosin (eosin yellowish 1.0 g; distilled water 100 ml); (3) lithium carbonate 11% (lithium carbonate 1 g; distilled water 100 g); (4) acid alcohol 1% 70% (alcohol 99 ml conc.; hydrochloric acid 1 ml); and (5) Scott's tap water. In a beaker containing 1 L distilled water, add 20 g sodium bicarbonate and 3.5 g magnesium sulphate. Add a magnetic stirrer and mix thoroughly to dissolve the salts. Using a filter funnel, pour the solution into a labeled bottle. The staining procedure is as follows: (1) Bring the tissue or cell sections to water; (2) place sections in hematoxylin for 5 minutes (min); (3) wash in tap water; (4) ‘blue’ the sections in lithium carbonate or Scott's tap water; (5) wash in tap water; (6) place sections in 1% acid alcohol for a few seconds; (7) wash in tap water; (8) place sections in eosin for 5 min; (9) wash in tap water; and (10) dehydrate with graded alcohol solution.

Mount Sections. A specific marker is a molecule or a group of molecules, which is present in only a subset of the components of a biological specimen and therefore identifying specifically the components having the marker. Specific markers are frequently defined as antigens recognized by specific antibodies (monoclonals or polyclonals) and can be detected by immunohistochemistry. Another group of specific markers is defined by the capacity of these markers to hybridize, specifically, a nucleic acid probe. These markers can usually be detected by in situ hybridization. A third group of specific markers can be defined by their enzymatic activity and can be detected by histochemistry. A fourth group of specific markers can be stained directly, histochemically, using a specific dye. A fifth group of specific markers can be defined as being receptors binding specifically to one or several ligands. A specific ligand is itself used for the detection of the receptor-ligand complex, using a detection method involving either histochemistry, or immunohistochemistry or in situ hybridization.

Immunohistochemical and In Situ Hybridization Techniques. Immunohistochemical techniques as used herein encompasses the use of reagents detecting cell specific markers, such reagents include, for example, as antibodies and nucleic acids probes. Antibodies, including monoclonal antibodies, polyclonal antibodies and fragments thereof, are often used to identify proteins or polypeptides of interest in a sample. A number of techniques are utilized to label objects of interest according to immunohistochemical techniques. Such techniques are discussed in Current Protocols in Molecular Biology, Unit 14 et seq., eds. Ausubel, et al., John Wiley & Sons, 1995, the disclosure of which is incorporated herein by reference. For example, the following procedure is an example of immunohistochemical staining using an antibody recognizing, specifically, the HER2 protein. HER2 overexpression has been described as a specific marker in a high percentage of breast cancer carcinomas. This protocol is intended for staining a paraffin embedded tissue section prepared according to a conventional procedure.

The section is deparaffinized using two baths of xylene and rehydrated through graded alcohols baths and finally in deionized water. The section is then incubated with an Antigen Retrieval Buffer, containing Citrate, for 40 minutes at 95. degree. C. The slide is then cooled down at room temperature for 20 minutes in the same buffer. The slide is then rinsed in deionized water.

The area surrounding the tissue section is carefully dried and a hydrophobic delimiting pen is used to draw a line around the specimen, on the glass slide. A peroxidase blocking solution is added on the section and incubated 5 minutes at room temperature. After being washed twice with the Wash Buffer (a balanced salt solution), the tissue section is incubated 30 minutes at room temperature, with the primary antibody recognizing the HER2 protein.

After 3 washes with the Wash Buffer, the tissue section is incubated with the peroxidase conjugated secondary antibody. The secondary antibody will recognize specifically the primary antibody. The slide is then washed 3 times with the Wash Buffer. Then the tissue section is incubated in presence of DAB and hydrogen peroxide for 10 minutes, before being washed with water.

The tissue section is counterstained in Hematoxylin for 2 minutes and rinsed again with water. The slide is mounted with a cover-slip using an aqueous mounting medium. Immunohistochemical localization of cellular molecules uses the ability of antibodies to bind specific antigens, for example proteins of interest such as onco-proteins and enzymes, with high affinity. These antibodies can be used to localize antigens to subcellular compartments or individual cells within a tissue.

In situ hybridization techniques include the use of specifically labeled nucleic acid probes, which bind to cellular RNA or DNA in individual cells or tissue section. Suitable nucleic acid probes may be prepared using standard molecular biology techniques including subcloning, plasmid preparation, and radiolabeling or non-radioactive labeling of the nucleic acid probe.

In situ hybridization is often performed on either paraffin or frozen sections. Such techniques often include fine sectioning of tissues to provide samples that are only a single to a few cell layers thick. For example paraffin blocks containing a tissue sample are cut into thin, approximately 8 μm tissue sections, which are subsequently mounted on subbed slides to be further processed for in situ hybridization. Alternatively, methacrylate may be used for sectioning. Cryosectioning techniques are particularly suitable for immunohistochemistry and enzyme histochemistry.

Immunofluorescent labeling of a tissue section often use a sandwich assay or a primary antibody and secondary antibody-fluorochrome conjugate. Slides containing a tissue section of interest are washed in phosphate buffered saline and then exposed to a primary antibody which will bind to the protein object of interest. Subsequently the slides are washed and exposed to the secondary antibody which binds to the first or primary antibody. The slide is washed and then developed. Numerous other techniques well known in the art of immunohistochemical staining and in situ hybridization are easily adaptable for use in immunohistochemical reconstruction as disclosed herein.

Thus, a combination of techniques using both chemical staining and/or immunohistochemical and/or in situ hybridization may be used in the present methods. For example, numerous subsamples may be prepared from a single tissue specimen. A first subsample may be chemically stained as discussed above, and a subsequent subsample may be subjected to immunohistochemical and in situ hybridization techniques. Each subsamples is scanned and processed as discussed below.

In an exemplary embodiment, the staining and imaging routine comprises acquiring image data from a tissue sample that has been stained or labeled in at least one of the following schemes: i. endogenous signals—The raw cut section contains fluorescent mineralization lines with the mineralized portion of bone and GFP based cellular signals either within or on the surface of the bone. The mineralized bone is captured by dark field optics, while the fluorescent signals a captured by a plurality, e.g., 4-5, of separate fluorescent filters; ii. Immuno and in situ fluorescent signals—Both widely used detection techniques will work with this type of histology preparation. Use of a fluorescence based detection system allows for convenient overlying of images; iii. Enzymatic staining for endogenous cellular activity—Cryosections retain biological activity better than any other histological medium. Use of fluorescence-based substrates facilitates overlying of images; iv. Colormetric staining for traditional cellular imaging—Standard histology is the last step because it precludes additional manipulations. It is performed to give the user a familiar frame of reference to interrelate the prior fluorescence based histology.

In certain embodiments, multiple tissue sections are prepared and attached to each slide. In a further embodiment, the microscope is controlled by the computer.

In another aspect, any of the methods described herein may further include a step of assembling the overlaid images for analysis.

In any of the methods described herein, a plurality or series of images of the tissue are acquired and/or tiled from before and/or after performing the staining protocol. In still an additional embodiment, the images from each ROI are tiled. Still in another embodiment, the method comprises a step of assembling and/or overlaying multiple tissue images for analysis. The system and method provided by the invention also includes a computer processing and display that is configured such that it allows a comparison of all the ROI images taken, wherein a difference in the ROI at any given time point, as demonstrated by the staining protocol, is indicative of a change in the tissue. As such, the system and methods of the invention provide for the visualization of changes in growth, differentiation, metabolism, pathological state, or the like.

In another embodiment, the method further includes a step of assembling the overlaid images for analysis, e.g., through the use of computer software configured to process the data as further described below.

a. Exemplary Method for Histomorphometry Imaging of Bone.

In an additional aspect, the description provides methods of performing bone histomorphometry, the methods being as described herein. In one aspect, the present invention provides rapid, automated, and relatively inexpensive systems and methods to cut and image non-decalcified bone and teeth that preserves the quality of the tissue structure and enables the detection of the fluorescence based signals without significant background noise. In addition, the systems and methods provided by the invention allow for the application of a large number of sensitive fluorescence based assays that currently are not possible on non-decalcified bone.

Bone is a dynamic tissue that is constantly subject to metabolic processes that include bone resorption (i.e., degradation), and bone formation. In healthy individuals, these competing processes are balanced such that the amount (i.e., volume and density) of bone remains essentially constant. However, the metabolic cycle of bone formation and resorption is unbalanced in a number of bone diseases and pathological conditions. For example, in senile osteoporosis, bone absorption surpasses bone formation, thereby causing a reduction in the amount and strength of bone. On the other hand, in osteomalacia, calcification is obstructed during bone formation, whereby bone formation is stopped at the stage of the bone substrate to increase the bone tissue not calcified, namely osteoid.

Accordingly, diagnosis of the dynamic state of bone in such diseases, namely the balance in the metabolism cycle, becomes important, but there is no efficient method according to the bone histomorphometry in which the test specimen obtained by bone biopsis is measured by microscopic observation. The key step in bone histomorphometry is to quantify skeletal parameters in tissue sections. The typical approach is to prepare tissue samples, then section, stain and image the prepared samples, and finally examine the images with a microscope equipped with image analysis software. The objective is to assess bone volume and the regulatory mechanisms that might lead to understanding of skeletal pathologies following the prescribed treatments of the samples.

Traditionally, the quantification of skeletal parameters is done manually by a technician who invests many hours visually inspecting the stained samples and tracing regions by hand using drawing software under the microscope. Numerous cost issues and quality control issues exist due to the labor intensiveness of the process. Nonetheless, this manual processing has been the norm for the past 20 years since the seminal bone volume measurement proposal has been published (Parfitt, A. et al., “Bone histomorphometry: standardization of nomenclature, symbols, and units,” J. Bone Miner. Res. 2, 595-610, 1987). However, due to the sheer cost issue, there are only a few institutions engaging in bone histomorphometry.

Generally speaking, bone is not homogeneous, and its form is different even in the same bone specimen depending on the site to be evaluated. For this reason, to enhance the precision and reproducibility of an evaluation, it is necessary to take a large number of measurement sites of, for example, 50 fields of sight, to obtain the evaluation results for the respective sites and obtain an average value thereof. Also, in this sense, it may be said to be indispensable that a further spread of the effective bone form measurement be made to efficiently perform an evaluation at the respective portions.

Another typical problem arises because all of the traces (e.g., trabecular bones and cells) are performed one by one, and the process is performed in a dark room and, therefore, it is very time consuming. For example, the current technology requires that the tissue, e.g., bone, is embedded in a dense plastic block and cut with a powerful microtome. While the quality of the resulting section is excellent, the process takes about 4 weeks to accomplish. In addition, the background autofluoresence is high and the cellular activities used to produce cell specific stains are often leached out.

In the case of bone, e.g., to overcome the cellular losses a second bone must be decalcified and embedded in paraffin for traditional color based histology because the more sensitive fluorescence based assays do not overcome the autofluoresence of paraffin embedded tissue. In some cases, the decalcified bone is embedded in ultra-cold freezing mixture and the frozen block can be sectioned. Once thawed, the advantage of a frozen section can be appreciated, but the quality of the section can be marginal. Thus to extract the full information within growing or remodeling bone it takes multiple histological procedures, highly skilled technicians and a long preparation time. Overall the cost of carrying out the traditional bone histomorphometry can be prohibitively high.

Therefore, in one aspect the invention provides a method for performing bone histomorphometry comprising the steps of using a tape transfer media that does not have an autofluoresence background that will not compromise the sensitivity of the histology; attaching the non-specimen side of the tape to a standard slide using a non-fluoresent adhesive. In an embodiment, the method may include a step of attaching multiple sections per slide (e.g., up to 12) so that all specimens from an experiment are contained on two slides and are treated equally (from staining to imaging). This is the most technically demanding step and, currently, can be performed at a rate of 15 min per section using stereo microscope equipped cyrostat to rapidly select the appropriate section. Next, the method includes the use of a computer controlled fluorescence microscope and mechanical stage to define a region of interest (ROI) within each section on the slide, wherein a series of tiled images from each ROI is created as an automatic imaging routine not requiring human input. Thus, in certain embodiments, the method includes the step or providing a processor or computer readable medium storing a program for executing an automatic imaging routine. In certain embodiments, the method further comprises one or more steps of removing the slide set from the microscope, performing a staining protocol, and reinserting the slide and reimaging the same ROI, wherein the precision allows automatic registration of the new image with the previous image. In a preferred embodiment, the method includes a step of providing a storage device and one or more steps of storing the histomorphometry image data to the storage device. In a preferred embodiment, the method further comprises a step or providing a storage device in communication with the processor or computer readable medium comprising program causing a computer to execute a process comprising at least one of storage, processing, querying, accessing, retrieving, displaying, analyzing, comparing, or combination thereof, of the histomorphometry image data.

The systems and methods described herein can minimize the human involvement by applying image processing techniques and image recognition techniques to the acquired individual fluorescence and stained images. The systems and methods described herein automatically produce assembled images, generate a fused image, select region of interest, and quantify dynamic and static bone activities. The system and methods described herein also use adaptive threshold techniques to segment the bone areas, and cell lineages. Nonlinear object recognition technique can also be used to assemble the individual images and to fuse multiple assembled images which are registered. Then, using morphological transformation, one can automatically compute bone activity parameters which are represented as dynamic and static quantification.

Tissues that are processed under aqueous but frozen conditions retain endogenous fluorescent signals, enzymatic activity and epitope reactivity to a greater degree than paraffin or plastic embedded tissues. The primary drawback of frozen histology is the quality of the histological section, and this particularly true for non-decalcified tissue.

In certain aspects, the systems and methods described herein provide for processing non-decalcified sections of bone and teeth that preserves the integrity of the tissues and maintains the advantages of frozen histology. However, the systems and methods as described herein are readily amenable for use with any biological sample and, therefore, their application as such is expressly contemplated herein.

There are four major technical steps that make this approach to bone histomorphometry faster and more informative than traditional plastic embedding techniques. Each will be illustrated separately.

1. Tape capture of a tissue section and adhesion of the tape to a standard glass slide: The most widely used tape transfer system (CryoJane™, www.instrumedics.com) requires that the capture tape is removed from the section after the sections is fixed to their proprietary slides. This step is required because the tape has an autofluorescent background that will interfere with fluorescent images. The tape removal step works well for standard tissues and decalcified bone. However for non-decalcified tissues, the tape removal step is very disruptive to the trabecular architecture. Another tape supplied by Finetec (www.finetec.co.jp) lacks the autofluorescent contamination so that the tape does not have to be removed from the section and thus does not disturb the fine structure of a non-decalcified section of bone.

Sectioning the undecalcified bone specimen. Using an unmodified research grade cryostat, a segment of tape is cut that will encompass the size of the bone section. After the specimen is trimmed to the site where the sections will be acquired, the tape is placed over the block and rolled to smooth out any non-contact points. The disposable cryostat blade cuts beneath the tape leading the section to be removed without disruption to the tissue architecture. Once freed from the block, the section can be transferred to a slide with forceps. Multiple sections can be placed on a standard slide without adhesive for storage and subsequent manipulation.

Subsequent steps allow one or more individual sections to be permanently attached to a glass slide with a gelatin/chromate adhesive. The tape side of the section is adhered to the glass and the exposed surface of the section is covered with glycerin and a glass cover slip.

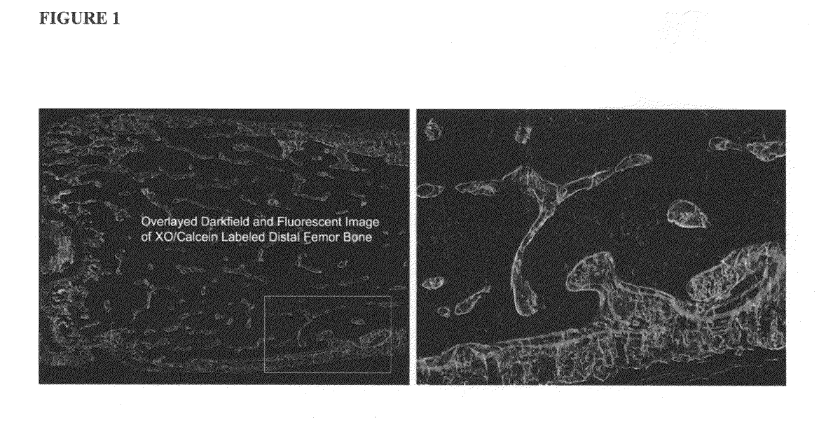

The sections are viewed with a research grade upright microscope that allows multiple modes of imaging all of which is computer controlled. This allows the section to be imaged for mineral in dark field and then in fluorescence for a mineralization line marking areas of active bone accretion (see FIG. 1) or GFP present in various cellular elements (not illustrated).

FIG. 1 illustrates the preservation of the fine trabecular vertebra. The fluorescent red and green lines are projected onto the mineralized regions of bone matrix. The green dye was injected into the mouse 7 days before sacrifice while the red dye was given 1 day prior to sacrifice. The distance between the two lines indicates the amount of surface bone that was formed during the 6 day interval. This stage of imaging is called stage 1.

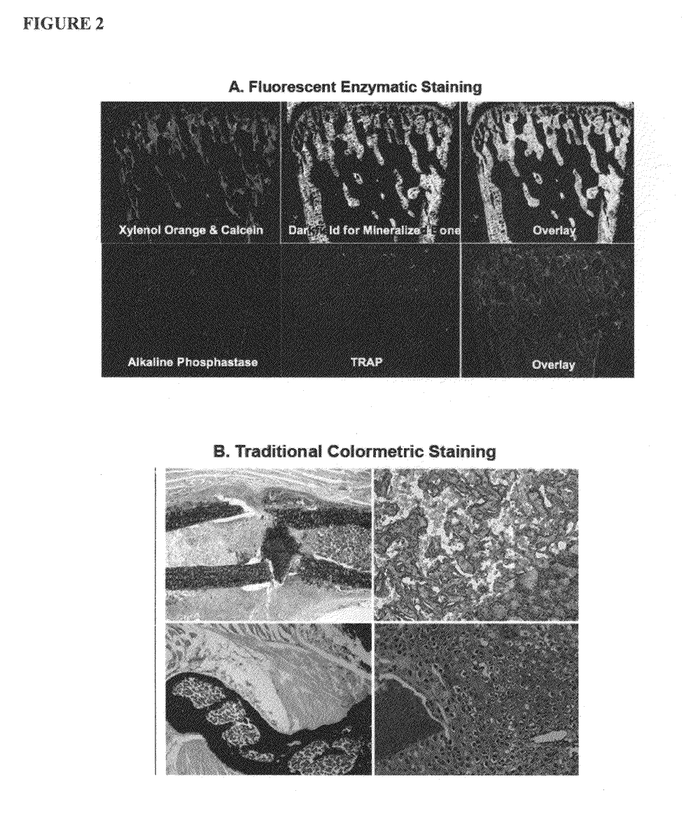

After the slide has been imaged for its endogenous fluorescent signal, it is removed from the stage for an enzymatic stain for alkaline phosphatase (AP, bone cells) and acid phosphatase (TRAP, osteoclasts) and then reinserted for a second round of fluorescent imaging (stage 2). Because the enzymatic staining protocol conditions remove the bone mineral from the slide, the dark field landmarks from the original sections are lost. However image registration techniques and the computer software/mechanical stage allows the two stages of imaging to be aligned. FIG. 2A illustrates the ability of overlaying the stage 1 and 2 images so that the AP and TRAP expressing cell on the bone surface can be related to the mineralization activity. Once the stage 2 imaging is completed, the slide is removed for traditional chromogenic staining (stage 3) that is helpful for the scientist in relating the fluorescent signal to a familiar view of the bone structure. Most of the stains for bone, tendon/ligament, cartilage, muscle and bone marrow elements can be stained with water based stains avoiding stains that require alcohols or dehydrating agents that cause shrinkage of the tissue elements away from the bone structure (FIG. 2B). This permits better registration of the chromogenic stains with the fluorescent images. These three stages could form the basis for commercial service for preparing murine bone for quantitative histomorphometry.

Using a second slide that is a replica of the original but uses the adjacent section of each block, the slide is stained by von Kossa to produce a black mineralized bone followed by toluidine blue to stain the nonmineralized bone matrix adjacent to the mineralized bone (images not shown). This procedure allows the unmineralized osteoid to be assessed. Because this measurement is not related to the cellular and dynamic measurements and cannot be incorporate into the fluorescent imaging routines, it is performed on separate sections.

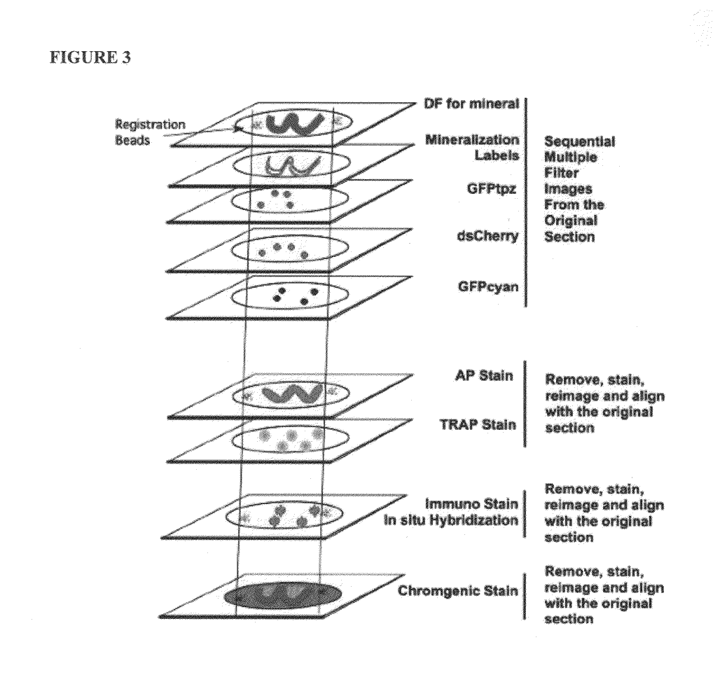

2. Alignment of multiple images of the same section: The feature of the imaging strategy that distinguishes it from traditional methods is the ability to interrelate the endogeneous and experimentally produced fluorescent signals with traditional histology (FIG. 3). It allows for a wide variety of standard and cutting edge imaging technologies to be incorporated into bone histomorphometry. For example, the use of all colors of GFP reporters is possible because the fluorescence is retained in the frozen sections while it is lost in plastic and greatly diminished in paraffin embedding. Thus in the first round of imaging for endogenous fluorescent signals (stage 1), the GFP coming from within or on the surface of bone or within the bone marrow can be readily distinguished from the mineralization lines and oriented to the bone through the dark field image. Depending on the fluors available and experimental design, the sample can be immunostained or taken through a fluorescent in situ stain with varying degree of loss of the endogenous signals. These steps can be preceded or followed by staining for endogenous enzymatic activity such as AP, TRAP or LacZ (for β-galactosidase reporters). The final step is the chromogenic stain that destroys all the fluorescent signals.

The addition of a cluster of fluorescent beads, the type used to standardize a fluorescent activated cell sorter (FACS) provides an additional aid to automating image analysis (FIG. 3). The beads remain attached to the tape through all the processing steps and provide a correction for any minor shrinkage in the tape during these steps. In addition they provide a constant fluorescent signal that can be used to normalize exposure across slides and experiments to correct for changes in bulb intensity.

The users receive a series of Photoshop files containing a stack of images that can be view singly or in any combination. For measurement purposes, each signal is viewed as a single view of a specific stain. Each file is recorded as a grayscale image that the user can pseudo color to bring out relationships that emphasize the findings of the research study. Because the signals are very specific for each staining step, it will be amenable to commercial quantitative imaging techniques that require manual identification steps. Our approach will have provided these identification steps automatically allowing the quantitative software to process samples more rapidly and avoiding the unpredictability of human judgment for manual identification. With the right combination of processing and analysis steps, a service of high throughput and automated bone histomorphometry could be developed that would be affordable and responsive to the needs of researchers and drug developers involved in bone research.

3. Mounting and imaging multiple sections per slide: We have explored how to increase the efficiency of sample preparation and imaging that might make a commercial service economically viable. A stereoscopic microscope with a swing arm was obtained to facilitate to sectioning process. Prior to this acquisition, the technician cut the sections to an approximate site and then examined the section on a standard microscope to determine if the section was at the correct depth. With the swing arm stereoscope, the technician knows when the right depth has been achieved before the section is taken thus avoiding the trial and error steps. No tape is wasted and only sections that will be used for the analysis are consumed (a considerable savings in technician time and supply costs). Furthermore by using smaller sections of tape, it is possible to place multiple sections onto a single slide. In the case of bone, each bone is cut separately from a block and the sections are arranged as test bone and control bone within the same slide. Up to 8 bones per slide can be routinely placed so that an entire bone histomorphometry experiment can be placed onto two slides. In the case of calvaria that are used in a model of bone repair, the bone are stacked similar to a pile of hats and embedded in the cryostat medium. Blocks containing four-stacked bone are cut with the aid of the microscope to ensure that the regions where the repair process is happening are contained within the section.

Placing multiple sections on a single slide has a number of advantages for consistency and efficiency required by a through put approach to bone histomorphometry. Because test and control are adjacent to each other, the fluorescent signals will not vary due to differences in bulb intensity or variations in fluorescent substrate reactions. All section will be treated identically. Technically, the scanning process can greatly augment imaging process utilizing a feature of the Zeiss microscope called “mark and find.” By defining the coordinates (start point and scanning dimensions) for each region of interest (ROI) that also includes the Z axis at each ROI, each bone can be scanned without further human interaction (stage 1). A series of 8-16 files are created per slide that is saved in a named file. Subsequently the slide is removed from the microscope, stained for AP and TRAP, returned to the microscope and recalibrated to a preset zero point after which the same ROIs are rescanned again without user input (stage 2). The process is repeated a third time after a chromogenic stain (stage 3). Thus a series of three image files for each ROI are created which can subsequently be stacked for inspection or analysis by the user. Other staining step such as GFP expression, immuno or in situ staining can be added to this routine.

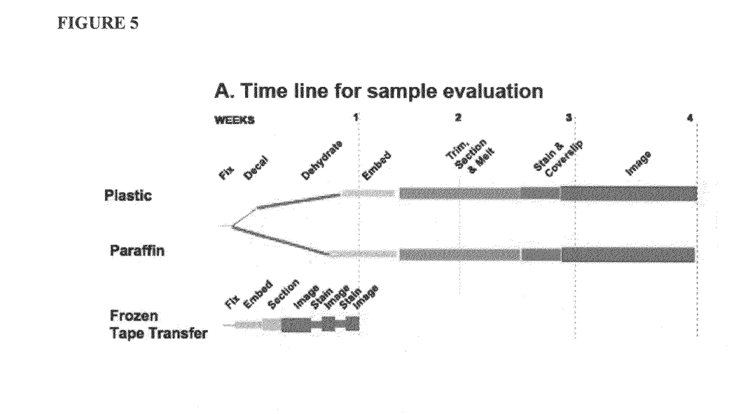

The system and methods described herein are a significant advance over current methods. Fore example, FIG. 5(A) compares the estimated time lag for processing the samples and generating a tiled image for a subsequent image analysis. The traditional method has significant lag times for tissue embedding and sectioning and prolonged times to manually scan single images per slide particularly when both paraffin and methymethyralate are processed. The presently described approach has only one time intensive method when the multiple sections are placed on the slide. The automated imaging step is a major technician time saver allowing this individual to process more samples. Using the systems and methods described herein, work flow can be done in less time and will produce a product that is more informative and amenable to image analysis than the traditional method.

Imaging and Imaging Analysis

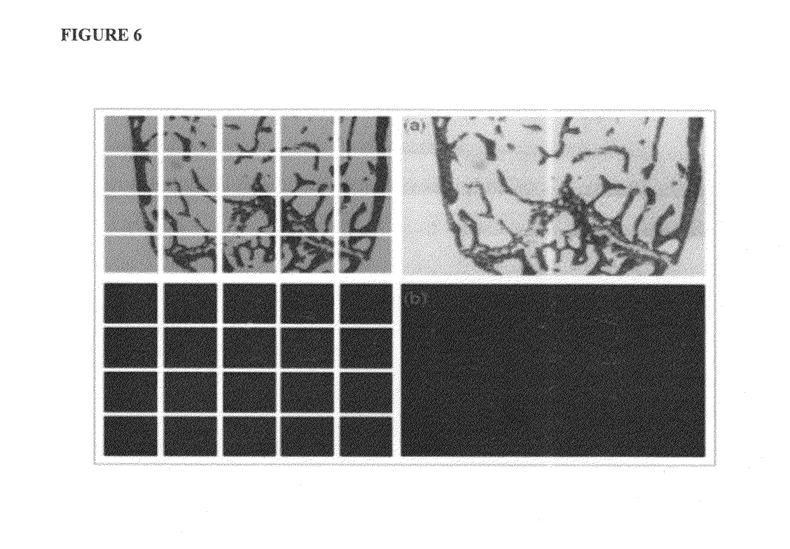

Presently described is the novel and surprisingly efficient combination of imaging (fluorescence microscopy imaging) and image analysis techniques (registration, segmentation) which are amenable to automating histomorphometry analysis. In an exemplary embodiment, the quantification included green fluorescence protein (GFP) labeled osteoblast surface, mineralizing bone surface and total bone surface. A test non-decalcified femur section of skeletally mature mice is scanned at 10× to produce an assembled image of the entire field of view using non-linear pattern recognition technique. The slide is removed for a staining step and returned to the microscope for repeated imaging. FIG. 6 illustrates that image assembly has been done for both Von Kossa (VK) stained images and signal (label and GFP) images. Two sets of assembled images are aligned using image registration technique (nonlinear correlation) in order to quantify the relationship of the labels and GFP marked osteoblasts over the bone. The cortical bones, trabecular bones, osteoblasts, and osteoclasts are automatically segmented and recognized.

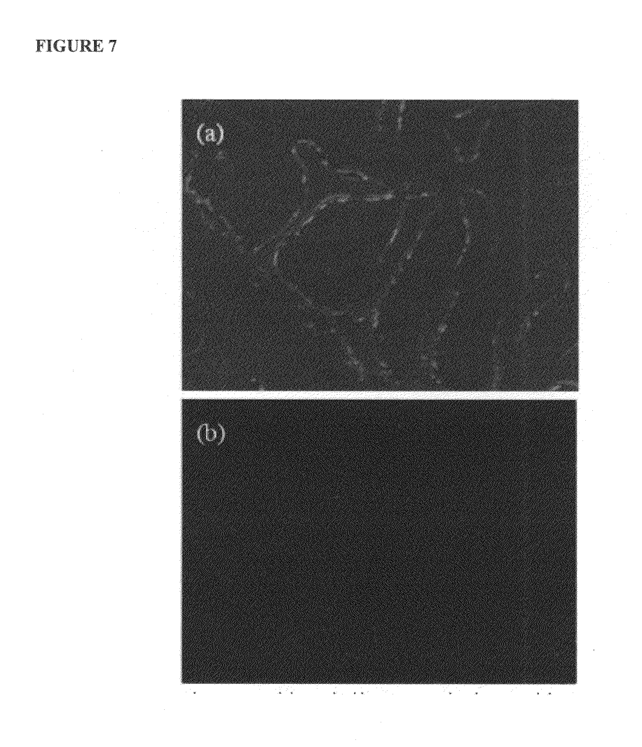

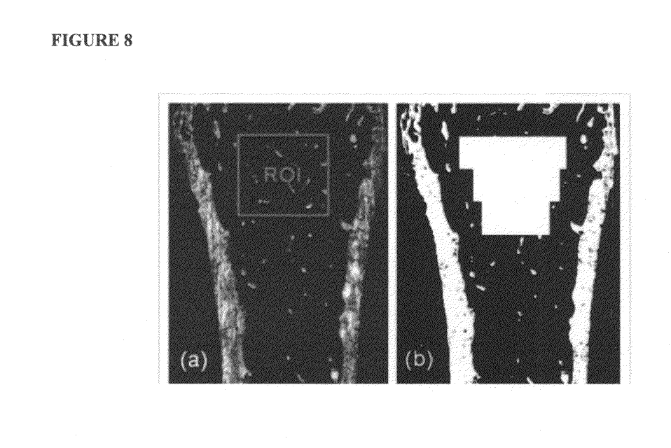

The next process is done by selecting ROI, projecting cells/labels onto the surface of the trabecular bones, and measuring parameters. These procedures are carried out automatically. Surface ratio computation is needed to compute relationship between the bone and labels. It is achieved by projecting labels onto bone surface using morphological processing. Often, the distance between the labels (the GFP marked osteoblast) and the bone surface are not uniform, even in a single segment of the label line or cell line. In order to find the precise ratios of the labels (and GFP marked osteoblast) over the bone surface, labels (and GFP marked osteoblast) are relocated on the surface of the bone surface with morphological transformation. FIG. 7(b) is the transformed image of FIG. 7(a). The red and green colors show, respectively, the labels and the GFP marked osteoblast on the bone surface. The yellow color is introduced to represent the common areas of labels and GFP marked osteoblast. From this projected image, we are able to calculate the ratios of the labels and GFP marked osteoblast of interests. The general rule for determining region of interest (ROI) for mouse femur is to find the trabeculae area which is located 400 μm below growth plate and 200˜400 μm inside of endosteum. During manual processing, a human analyzer typically investigates multiple 250 μm×250 μm areas within trabeculae and measures signals and bone areas inside the squares as shown in FIG. 8(a). FIG. 8(b) illustrates that such a decision of ROI can also be done automatically. By selecting ROI using a computer, it is possible to obtain much more sophisticated ROIs than those obtained manually using current quantification systems. The above example demonstrates that the described automatic or semi-automatic approach is surprisingly better than the manual approach.

Image processing generally involves three steps, segmentation, registration and enhancement. For the segmentation we use both Otu's segmentation (Otsu N., “A Threshold Selection Method from Gray-Scale Histogram”, IEEE Trans. Systems, Man, and Cybernetics, 1978, 8:62-66) and snake algorithm (Xu C, Prince J L. “Snakes, Shapes, and Gradient Vector Flow”, IEEE Transactions on Image Processing, 1998, 7:359-369). Segmentation involves thresholding. In certain embodiments, the algorithm published in Leung C K, Lam F K, “Performance analysis of a class of iterative image thresholding algorithms”, Pattern Recogn. 1996, 29(9):1523-1530, can be used. For the registration, a simple warping technique may be used. In our application (bone histomorphometry) extracting a feature is very difficult. To overcome the difficulty we artificially introduced “beads” on the image, and we extracted the beads and used simple warping to register the multi channel bone images; this warping approach is suitable for this type of registration. In certain embodiment, the feature extracting technique of Javidi B, Homer J L, Real-Time Optical Information Processing, Academic, 1994, can be used. In additional embodiments, dilation and/or median filtering image enhancement techniques can also be used. These techniques are broadly available in image processing textbooks such as (Gonzalez R C, Woods R E. Digital Image Processing, Pearson Education, 2002), (Jain A K. Fundamentals of digital image processing, Prentice-Hall, 1989) and (Shapiro L G., Stockman G C. Computer Vision, Prentice-Hall, 2001). In certain additional embodiments, for the quantification, basic pixel counts and measurement of distances between identified segments can be used. These are done through straightforward arithmetic computations.

There have been a very large number of algorithms developed and publicized in the past for image segmentation, registration and enhancement. Many different combinations of algorithms can be applied for the automation of bone histomorphometry. The algorithm is comprised in a series of MatLab scripts. As MatLab is generally for rapid prototyping, conventional computer programming languages such as C++ and/or Java will be used for development of the commercial platform.

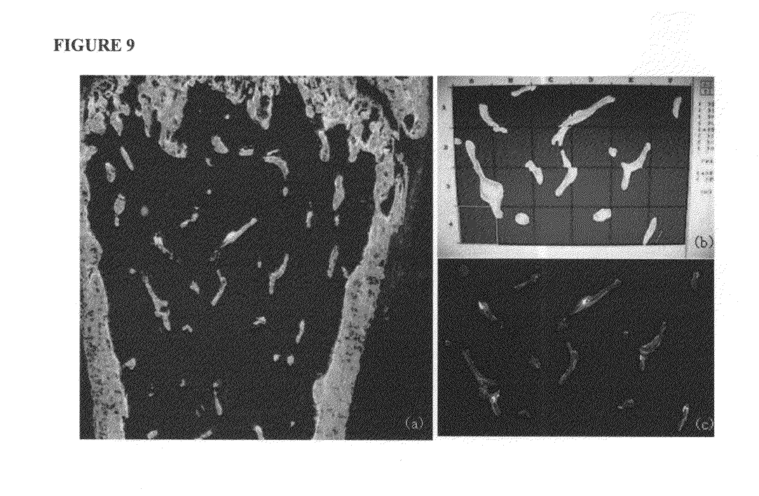

FIG. 9 demonstrates and example of an histomorphometry image data processing method suitable for the systems and methods described herein. Starting with the same image (FIG. 9(a)), a bone histomorphometry expert independently carried out the analysis using the conventional method with OsteoMeasure (FIG. 9(b)). Both approaches used the same ROI. FIG. 9(c) is the outcome from the automatic segmentation as described herein. The comparison of the outcomes from the manual image analysis and automated image analysis process descried herein are provided in Table 1.

TABLE 1
Summary of major dynamic and static indices from the two methods, one automatic and one manual.
There are slight variations, but more or less both results appear to be very comparable.
The measurement follows the standard guideline of bone histomorphometry presented in [Parfitt et al., 1987].

| | sLS/BS | dLS/BS | GFP/BS | Ir.L.Th | MAR | LS/BS | BV/TV |
|---|---|---|---|---|---|---|---|
| | (%) | (%) | (%) | (μm) | (μm/day) | (%) | (%) |
| Manual | 14.95 | 22.40 | 7.91 | 15.38 | 2.20 | 37.35 | 8.61 |
| Automated | 12.32 | 26.13 | 8.32 | 15.36 | 2.19 | 32.29 | 8.60 |

The average processing time for quantifying one mice femur using invented automated quantification method is about 90 seconds. With manual approach, it could take from 15 minutes to 30 minutes. Thus, the described methodology can automate the bone histomorphometry with enhanced reproducibility and improved precision and objectiveness.

Exemplary construction of comprehensive genetic atlas using the system and methods described herein. With the completion of the human and mouse genome project, the daunting task of assigning function to the genetic units began. The goal is to individually assess the impact of genetic units that could act in a quantitative manner to incrementally increase or decrease one's susceptibility to disease as challenged by the environment. This knowledge is the holy grail of molecular medicine in which individual risk can be assessed from genetic sequence. However there is a huge knowledge gap between gene sequence and gene function that must be closed to achieve this eventual goal. While the global gene knockout projects currently being carried out in the United States and Europe will ultimately inactivate every genetic unit, the problem that is currently being grappled with is developing high throughput yet informative methods to identify phenotypes suggestive of gene dysfunction at the tissue level. However, even when this information is acquired, it does not explain why the phenotype developed or what cell type(s) are affected by the mutation. In addition, the impact of a mutant gene on multiple cell types may not be appreciated when the global knock out results in embryonic lethal outcome.

To overcome the problem of an embryonic lethal mutation and to better understand how genes function during development, transgenic mice carrying a gene promoter driving the Cre recombinase gene (Cre driver lines of mice) were developed to act upon a floxed target gene. When the promoter driving Cre gene is active in a progenitor cell, it causes a permanent inactivation of the target gene and this genetic change is passed on to all of the progeny of the originally targeted cell. However there is always uncertainty with this approach because the temporal and tissue pattern and strength of the Cre driver construct is not comprehensively known during development. This particularly true for an adult phenotype that could result from a direct effect of the KO on a known cell type (cell autonomous) or an indirect effect of the gene acting on another cell type (non-cell autonomous).

In contrast to knockout strategies, GFP reporters reveal lineage relationships and cellular activities within a complex tissue structure. In this case, the Cre recombinase gene acts upon the floxed reporter gene and all the progeny of that cell will express the reporter. This research strategy has been a major advance in developmental biology because it identifies the first time during embryogenesis that the reporter is activated and maps all the downstream progeny of the original cell. This principle of lineage tracing is widely used to demonstrate the relationship of different cell types within a tissue and can demonstrate the downstream effect of a mutation that is active in a progenitor cell. However its use in adult tissues and particularly those which undergo regeneration and repair is limited because it is never certain whether the Cre marked cells were present from early embryogenesis or developed from the activation of the gene in the adult progenitor cell population that participates in regeneration and repair.

The promoter-GFP reporter strategy provides a real-time assessment of active cells with tissues at the time the sample was harvested. The expression of GFP can be assessed over the lifetime of the mouse and shown to track with the development of various structures. While this approach has had a major impact for developmental studies using confocal fluorescent microscopy to detect GFP with optical sectioning, it has not been as successful in adult tissues in part because of the difficulty of maintaining the florescent signal in paraffin embedded sections. This is a particular problem in skeletal tissues, which have a high auto florescent background and resist penetration of the confocal beam. Resorting to antibodies for GFP, while sensitive and informative, is labor-intensive and technically demanding.

Using the system and methods described herein, a comprehensive map of histology of tissues can be created. The histology is sensitive to all colors of GFP using standard epifluorescent microscopy. By multiplexing different colors of GFP, it is possible to observe the transition of cells from one level of differentiation to the next as they acquire a different color of GFP associated with a particular stage of development. Thus in adult tissues it is possible to demonstrate lineage relationships during development or in a repair process in which the GFP signals can be mapped back to traditional chromogenic stains. Once the tissue and temporal pattern of expression is known of a particular promoter, it can be used to alter the biology of the animal in a cell/tissue specific manner by expression of a cell toxin, growth factor, siRNA, etc.

The knowledge gained from the systems biology and molecular genetic approach is combined to understand the impact of a gene in selected cell types of growing or fully adult animal. Once the pattern of GFP expression is defined in different tissues at different stages of growth, then a Cre reporter is created utilizing the same promoter construct (driver) that will replicate the same expression properties as the GFP. In fact, a fusion GFP/Cre protein can be produced to ensure that the two functionalities are co-expressed. For the Cre to function at a specific time in development or repair, the Cre is further modified to keep it inactive until the animal is treated with an activating drug such as tetracycline or tamoxifen. Thus the effect of a particular gene is studied in adult tissue even though the gene's action in the same cell type during development was an embryonic lethal. Promoters that drive Cre a functional gene that has biological impact such as a growth factor, cytokine or siRNA can control when the factor is activated by the cre-activating drug. Even more powerful is the expression of an RNA or a DNA binding protein that also carries a foreign antigen binding site that can be used for affinity isolation of RNA or DNA. This approach allows for microarray, ChIP-ChIP or ChIP-Seq binding studies from a specific cell types within a complex intact tissue. It can be used to differentiate cell of origin in a tissue transplantation experiment designed to distinguish the function of a mutant phenotype as cell autonomous and non-autonomous.

Thus the ability to express a functional protein (GFP, Cre, toxic gene, growth factor, RNA or DNA binding protein) provides the investigator with many tools to understanding systems biology at the molecular level and to relate these effects to tissue morphogenesis and the impact of gene function on the process. It provides a union between visual morphogenesis and molecular genetics in a way that is not possible with any other technological modality. Key to this evolution of scientific investigation is the knowledge of how promoter fragments and BAC constructs drive expression of GFP and Cre. The exemplary methods described herein provides a framework to assemble this information in a systemic manner, e.g., an atlas of GFP and Cre reporter mice utilizing the imaging process and systems as described herein. The system and methods described herein are advantageous in that they allow rapid tissue processing, automated and/or semi-automated tissue imaging, a database pipeline for image analysis, archiving and recall of the tissue sections and a mechanism to interact with experts in each tissue field to provide more in depth analysis of the images that require detailed study.

In an illustration of this aspect of the invention, we have made or acquired about 40 GFP-reporter and Cre-driver lines under control of either a promoter fragment, BAC-transgenome and endogenous gene trap design driving a GFP or Cre. In certain embodiments, the system comprises 4 components (A-D, below).

A. Cryohistology—The basis of the histology is a frozen section that preserves the visualization of GFP in adult tissues. Tissues are fixed in paraformaldehyde and embedded in OTC from which 5 μm intact full length sections are obtained using a tape to slide transfer process. The tape stabilizes the section and avoids the section flotation step. The processing time and technician skill requirements are greatly reduced relative to paraffin-based histology because the steps of dehydration and paraffin equilibration are avoided. Unlike paraffin histology, strong endogenous fluorescence signals can be detected within the frozen sections because the tape has a low auto florescent background. Using standard epifluorescent microscopy by the modern computer controlled imaging platform, it is possible to rapidly image multiple tissues on a single slide. The full spectrum of fluorescence from DAPI to Cy7 is detected by this histology allowing up to 6 colors to be obtained from a single section. On the same section fluorescence enzymatic, immuno and in situ histochemical stains can be superimposed and related to a specific GFP signal. Once the fluorescent images have been collected, the same section can be treated with a chromogenic stain such as H/E and reimage to associate the GFP signal with a familiar histological stain. Mineralized skeletal structures can also be sectioned in the image with this technology and has the additional advantage that the mineralized portion of the section can be highlighted with a calcium binding dye such as calcein blue while the mineralizing front can be detected if the animal is given an injection of tetracycline or calcein one day prior to sacrifice.

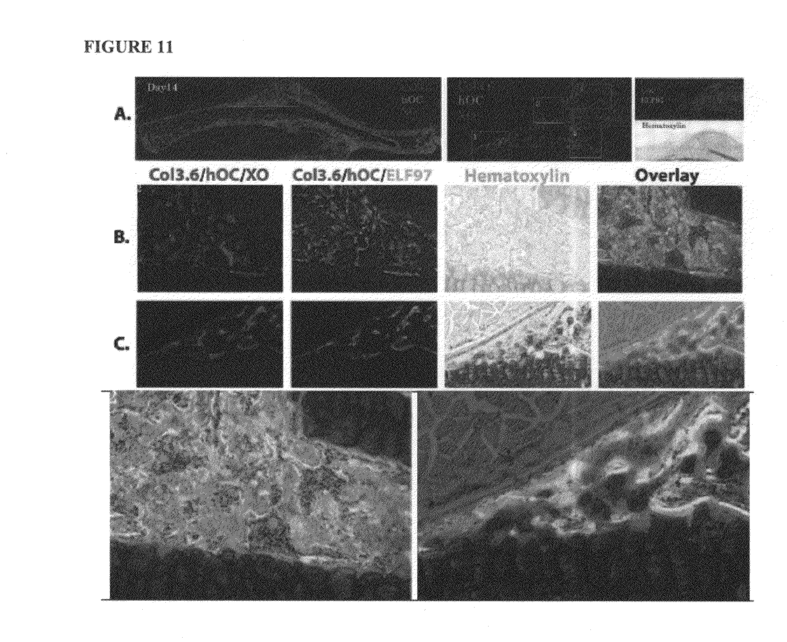

The multiple staining and imaging steps are aligned by adherence of fluorescent beads adjacent to the section (FIG. 3). An example of the power of the technique is illustrated in FIG. 11. In certain embodiments of this aspect, the system comprises a step of multiplexing reporters of different color that are active at different stages of the lineage, e.g., osteogenic lineage, which reveals the progression of cellular differentiation in a repair setting in adult tissue. The figure also illustrates the combination of a histochemical stain for tartrate resistance acid phosphatase (TRAP by ELF97, for osteoclasts), xylenol orange (XO red) for mineralizing surfaces followed by hematoxylin straining for cellular morphometry. While the examples given focus on skeletal tissues, it works equally well for soft tissues, including, e.g., bladder, lung, heart, or other.

B. Automated imaging—In any of the embodiments described herein, the system includes a microscope scanning platform (Mirax, Zeiss) that is able to automatically image a defined area of a slide (multiple regions) using a tiling algorithm that generates a view of the section on a computer as if one was observing the section with a microscope. In certain embodiments, the observer can see the entire section at low resolution or a restricted area at 20× resolution and has the option to capture images from these views that are acceptable for publication. In certain exemplary embodiments, the scanning microscope can capture a plurality of different filter settings and allows the observer to see them as separate layers or all merged together. In additional embodiments, the scanning microscope can capture up to 9 different filter settings and allows the observer to see them as separate layers or all merged together. Once the regions to be scanned are identified and the fluorescent setting defined, the entire set can be scanned overnight for processing the next day.

C. Visual file management and image analysis—Another feature of the system of the invention is an image filing and retrieval database that is directly associated with the microscope that creates the digital images. A series of computer algorithms upload the images into a preconfigured file structure. The program creates a thumbnail image within the database that can be associated with various annotation fields and allows the original image to be downloaded at full resolution. This database allows a mechanism in which images can be consistently filed, annotated, search and retrieve based on specific queries.

Using this file naming and retrieving database, we have established a pipeline to apply image analysis algorithms that will generate a numeric description of the image. In certain embodiments, a screening algorithm is utilized that detects the presence or absence of GFP in a tissue section, determines its intensity and general distribution. Once the analysis is completed, the results are ported to curated database for external evaluation.

D. Atlas—In certain additional embodiments, a curated database is provided to present the results of the study. The results of the image analysis are deposited for each study so that a user can search for the reporters that are active in their tissue of interest. Once selected, they are able to see either static images deposited in the visual file management system or can go to the server that maintains the original Mirax image. In either case, the observer can view the sections to determine if the expression pattern would be of value to their experimental use. In particular, it will indicate if the reporter is unique to their tissue of interest or is expressed in tissue that would not have been predicted by current knowledge. In certain embodiments, the database comprises reports or analysis of a reporter pattern submitted by experts in that tissue that interprets the expression pattern of the tissue to guide the user in their selection of a reporter line. In addition, information will be provided on where the animals can be obtained and publication related to the use of the reporter line.

A. Reporter mice available:

1. GFP reporters—While many of the reporters utilize eGFP this is a poor selection because its spectrum spills in too many other colors limiting the ability to multiplex. We will demonstrate reporters utilizing Cyan/ceuleon, Sapphire, Topaz/YFP/crimson, td tomato, Cherry and Crimson, and will provide examples where the reporters are crossed to multiplex more than one cell type per tissue. The expression pattern of Cre drivers will be determined by crossing these mice with mice carrying the TD tomato reporter which in our hands and others is consistently and strongly expressed in all tissues. The transgenic reporter available include:

TABLE 2
Mouse Transgenic Line/Intended Purpose.

| | |
|---|---|
| pOBCol3.6GFPtpz or cyan | Three colors that mark preosteoblast and early osteoblasts |
| pOBCol2.3GFPemd | Three colors that mark mature osteoblasts and osteocytes |
| hOC-GFP (Tpz and Citron) | Osteocalcin promoter (late osteoblast differentiation); |
| DMP-GFP (Tpz and *Chry) | Osteocyte differentiation |
| Col2A1-GFPcyan | Marks mature cartilage differentiation |
| Tie2-GFPemd | Marks endothelial cells |
| SMAA-GFPemd or Chry | Marks bone/fat/skeletal muscle progenitor cell (pericyte) |
| Ost-GFPCre | Osteix BAC transgenic for early preosteoblast differentiation |
| MyoD-GFPemd | Skeletal muscle differentiation |
| Dkk3-GFPemd | Active in periosteum, articular cartilage and tendon insertion sites |
| CTGF-GFPemd | Early bone progenitor marker |
| BSP-GFPtpz | Early bone differentiation marker |
| ColX-GFPChry | Hypertrophic chondrocyte marker |
| Sox9-GFPemd | Chondrocyte progenitor marker |
| Tnc-GFPchry | TenascinC = mature tendon marker |
| Scx-GFPcit | Scleraxis = early tendon marker |
| Tbsp2-GFPemd | Thrombospondin 2 - periosteal marker |
| TRAP-GFPcyan | Osteoclast reporter |
| AP2-GFPtpz or cyan | Active in adipocytes and macrophages and dendricytes |
| Cd11c-GFPred | Dendicyte marker |
| Dlk1-GFPcit | Pref1: Adipocyte progenitor; muscle satellite cells |
| IHH-GFPcit | Indian hedgehog: Prehypertrophic chondrocytes |
| TH-GFPemd | Tyrosine hydroxylase - sympathetic nerve |
| Nog-GFPemd | Noggin - chondrocytes |
| Cx3Cr-GFPemd | Reporter for macrophages (osteomacs) |
| CxCR12-GFPemd | Reporter for SDF1 receptor |

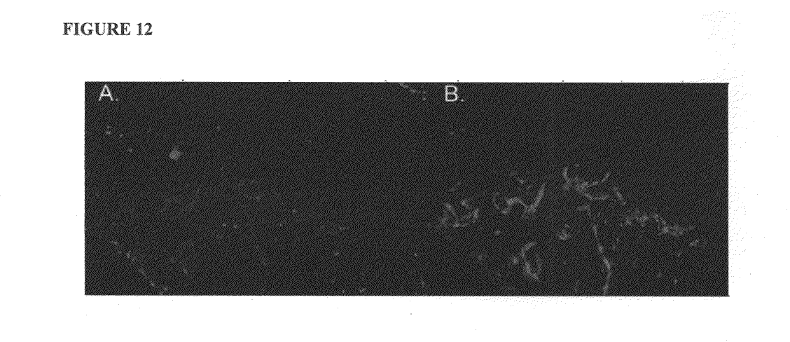

2. Cre reporter (FIG. 12)—Our experience with fluorescent reporters such as ZEG or ROSAGFP indicated inconsistency in the strength of their expression in different tissue types. The recent development of the td-tomato construct, Ai9, has proven to be far more reliable and very strong than prior designs. Because of this new development, we will cross the Cre drivers with the td-tomato reporter to determine the cells that are activated by the Cre driver. The cre drivers available are: Col3.6CreERT2, Col2.3CreERT2, OstCre-Tet off, DermoCre, SMAACreERT2, Prx2Cre, and DMPCre.

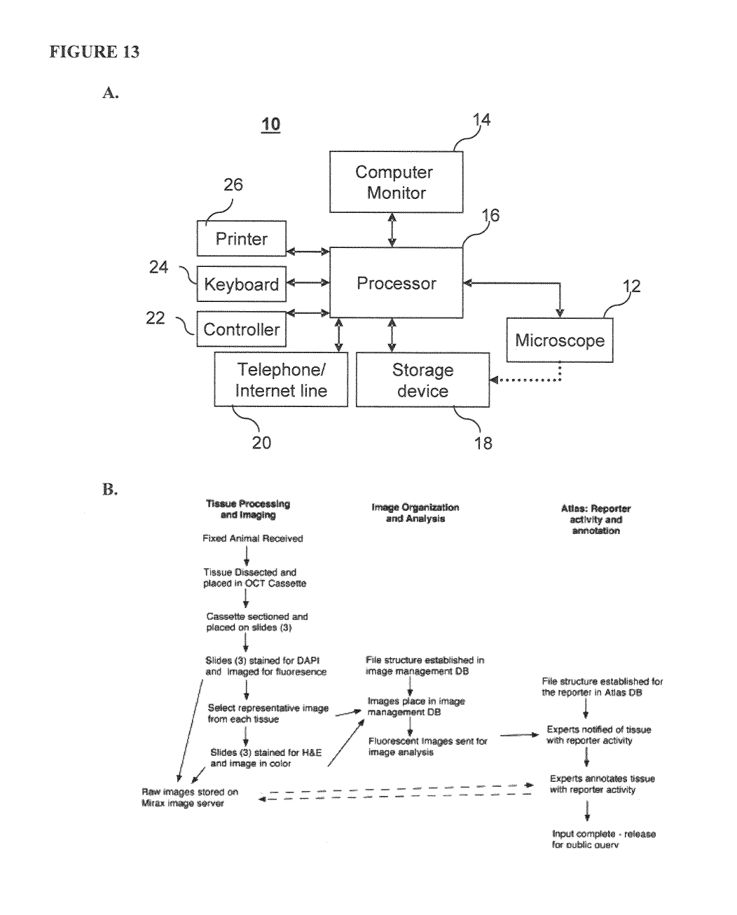

With reference to FIG. 13(B). 1. Neonatal pattern—Newborn animals are examined with a Zeiss Lumar stereoscopic microscope to determine the tissues that appear to be most active for the reporter. Signals are generated from the chest or abdomen, a crude dissection to isolate the major organs will be performed to distinguish which organ is responsible for the signal.

2. Preparation of the tissue survey of 4-6 week old mice—This time is selected because the animal is still growing rapidly but the structure is of sufficient size for histological manipulation. The mice will be injected with alizarin complexone or calcein to label mineralizing surfaces. Multiple organs will be distributed within a single OCT block to generate sections of related tissues. In certain embodiments, a plurality of slides per transgene are analyzed, for example, three slides per transgene are analyzed for the tissue screen: a. visceral tissue—liver, stomach, small intestine, colon, spleen, thymus, pancreas, testis, ovary, uterus, bladder; b. vascular tissue and dermis—heart, lung, aorta, kidney/adrenal, skin; c. skeletal tissue (slide 3)—Chest wall—sternum (fibrous cartilage, white and brown fat), knee joint (axial skeleton, endochondral cartilage, skeletal muscle), vertebra (axial bone, disc), TMJ (fibrocartilageous joint, teeth, alveolar bone).

3. Defining the file structure for the transgene—For each transgene, a naming file structure will be established that will be used throughout all the subsequent acquisition and management of images.

4. Imaging—The 3 slides from each transgenic animal will be stained with DAPI to provide context for the entire tissue. The slides will be imaged by the MIrax scanning microscope for the GFP reporter and other fluorescent signals (skeletal tissue). The named raw image will be deposited on the Mirax server (provides the user a view of the original image), and representative static images will be selected by the research staff for deposit into the image management database. The images of the newborn mouse tissues will also be added to the image management database.

5. Image analysis—The selected images will be ported to the image analysis program to provide a quantitative representation of each tissue. This step will separate tissue with little to no GFP activity from those that will need human observation for further analysis and interpretation (see annotation below).

6. Curated atlas—The file naming structure will be used to populate the publicly available database. It will begin with the image analysis data, which will include the images used in the analysis. However there will be links back to the original Mirax data for further analysis (see next). It will also include the neonatal expression pattern. The atlas will also contain a map of the transgene Cre or GFP, links to published articles related to the use of the construct and where the mouse line can be obtained.

C. Parallel tissue analysis and annotation (FIG. 13(B)). In still another embodiment, the invention provides a system for performing parallel tissue analysis and annotation. For example, the screening process distinguishes tissues that have varying degrees of GFP activity from those with little to none. However it will not identify what structure or cell type within the tissue that is responsible for the activity. The imaging and file management system allows multiple tissue experts to view original sections in greater detail regardless of their physical location and provide an interpretation to the atlas. Elements of this annotation/interpretation process will include:

1. Identify experts in developmental biology and pathophysiology of a specific organ with a background in molecular genetics to participate in the project.

2. The atlas will notify the appropriate expert that a tissue of their interest has been deposited that shows a certain threshold of reporter expression.

3. The expert reviews the tissue section and decides if sufficient information is present for an interpretation, or whether further histological sections are required.

4. Working with the expert, more sections of the specific tissue of interest can be prepared for either fluorescent or chromogenic imaging, or sections or tissue blocks can be sent to the expert for their hands on examination.

5. Once the expert examination is completed, a summary of the findings, its interpretation and relevance to the gene promoter being examined will be developed and submitted to the atlas.

D. Expansion of the atlas—At this stage only a demonstration of how the process will operate is being proposed. However if the design and implementation of the plan is successful, then the expansion would include:

1. Enroll reporter and cre driver lines deposited in the Cre driver project (Jackson Labs), the BACGFP project (Gensat) whose mice are found at the MMRRC website, investigator developed mice (nationally deposited at Jackson Labs or acquired directly from the investigator), and the European conditional mutagenesis program.

2. Deposit information developed by individual investigators using a particular reporter line. Because tissues can be transported by surface mail once fixed in paraformaldehyde, an investigator can submit a tissue and our staff can perform the preparation, sectioning and imaging to ensure that all images within the database are of similar quality and can be related across different tissues and transgenes.

3. Multiplexing reporters: Combination of reporters that are valuable to understand a process within a specific tissue is another application that would be appropriate for the atlas and helpful to investigators.

Automatic Image Analysis of Bone Histology

The combination of image analysis techniques (registration, segmentation, smoothing and thresh-holding) is amenable to automating histomorphometry analysis. We have used long bones (femur) of PTH treated, skeletally mature mice (8˜9 month old) whose transgenic expression of Col3.6GFP or Col2.3GFP is expected to be uniformly low. Each study had 2 groups of treatment experiments, one that is PTH treated and one that is vehicle (0.001 N HCl containing 1 mg/ml BSA) treated. Each treated study was terminated 1 day after 2 days, 3 days, and 7 days dose of treatment has been administered. A single red fluorochrome label (AC, alizarin complexone, 30 mg/Kg IP) has been administered concurrently with the final PTH dose approximately 24 hours prior to end of each study. The experimental quantification includes GFP labeled osteoblast surface, mineralizing bone surface and total bone surface.

Example of the AC stained label/pOBCol3.6 GFP marked osteoblast image is shown in FIG. 7(a). We need to measure both the AC stained label areas and GFP marked osteoblast areas that are commonly related to the same bone surface region. Often, the distance between the AC stained labels and the GFP marked osteoblast are not uniform, and sometimes they may be located far away. Our approach is to find the reference bone surfaces first, and then move the related AC stained labels and GFP marked osteoblast onto the reference bone surfaces using morphological transformation. FIG. 7(b) is the transformed image of FIG. 7(a). The red and green colors show, respectively, the AC stained labels and the GFP marked osteoblast on the bone surface. The yellow color is introduced to represent the common areas of AC stained labels and GFP marked osteoblast. From this projected image, we are able to calculate the ratios of the AC stained labels and GFP marked osteoblast of interest.

Table 3 summarizes the measurements derived from the image illustrated in FIG. 7(b). Here PTH treated and vehicle treated studies use poBCol3.6GFP-Tpz and pOBCol2.3GFP-Emd, respectively, where the former is control and the latter is test. The measurement follows the bone volume measurement guideline presented in [Parfitt et al., 1987]. In Table 3, the following notations are used and each measurement is the percentage of 2D perimeter measurement over the total 2D bone surface area (Red=AC measurements, Cyan=GFP measurements).

TABLE 3
Mean values of the ratio measurements of trabecula for day 7.

| | | AC measurements | | | GFP measurements | | |
|---|---|---|---|---|---|---|---|
| | | TL (%) | CL (%) | NCL (%) | TL (%) | CL (%) | NCL (%) |
| Col 3.6 | Vehicle treated | 10.62 | 1.19 | 9.43 | 2.82 | 1.19 | 1.64 |
| -Tpz | PTH treated | 31.23 | 5.47 | 25.48 | 9.99 | 5.74 | 4.24 |
| Col 2.3 | Vehicle treated | 4.57 | 0.76 | 3.81 | 4.66 | 0.76 | 3.91 |
| -Emd | PTH treated | 16.48 | 3.82 | 12.65 | 11.83 | 3.82 | 8.00 |

TL=total AC stained label area/bone surface area; CL=common surface area of the GFP marked osteoblast and AC stained label/bone surface area; NCL=surface area of the AC stained label only/bone surface area; TG=total surface area of the green GFP marked osteoblast/bone surface area; GL=common surface area of the GFP marked osteoblast and AC stained label/bone surface area; NGL=surface area of the GFP marked osteoblast only/bone surface area.

In this example, because we have used 1 AC stained label and 1 GFP marked osteoblast in each study, the values of CL and GL are the same. And TL=CL+NCL, and TG=GL+NGL. This table confirms the anticipated effect of PTH: there are more calcified bone areas (TL) and number of GFP marked osteoblast (TG) in the PTH treated case (test) than in the vehicle treated case (control).

Comparison Between Automated Method Provided by the Invention, and Manual Method

Our second attempt was to demonstrate that the automatic approach is comparable to the manual approach or even better. Starting with the same image (FIG. 9(a)); OsteoMeasure™ were used to carry out conventional analysis (FIG. 93(b)). Both approaches used same region of interest (ROI). FIG. 9(c) is the outcome from the automatic segmentation. Table 4 shows the summary of comparing major indices (explained below) of two methods.

TABLE 4
Summary of major indices

| | sLS/BS (%) | dLS/BS (%) | GFP/BS(%) | Ir.L.Th (μm) | MAR (μm/day) | LS/BS (%) | BV/TV (%) |
|---|---|---|---|---|---|---|---|
| Manual | 14.95 | 22.40 | 7.91 | 15.38 | 2.20 | 37.35 | 8.61 |
| Automated | 12.32 | 26.13 | 8.32 | 15.36 | 2.19 | 32.29 | 8.60 |

During this comparison study we have also identified two noticeable issues: (i) the manual process roughly follows the contour of the bone edge usually ignoring details of the surface suggesting that “surface smoothing” is necessary and desirable, and (ii) images may include ambiguous areas which would have to use subjective knowledge to discern. The second issue suggests the need for the human intervention and validation step within the automation.

Testing Data Reproducibility with Established Mice Strains, C57BL/6 and C3H.

The NIH and European murine genome knockout projects will form the functional basis for interpreting DNA sequencing as a predictive tool for the emerging field of molecular medicine. Because human biology is the summation of multiple genetic inputs that act during development and are recalled for homeostasis and in response to injury and repair, knowing how each function element contributes to a normal or pathological setting will be essential to this emerging interpretation of health and disease. It is only through a structured and ordered evaluation of each genetic unit that this goal will be achieved. While the technology for developing these knockouts has been well-developed and numerous knockout lines have been established through this combined effort (Table 2) as well as 300 knock outs created by individual investigators, it is the evaluation of these knockout lines that is the Achilles' heel of this lofty concept. The initial evaluation of these mice includes neonatal viability, signs of dysmorphology, and routinely available physiological and laboratory tests. However this is a relatively low yield endeavor because many of the genes either have a subclinical impact on the development and there are redundant mechanisms that can compensate for a genetic deficiency. This is particularly true for the musculoskeletal system in which many of the genetic defects are not appreciated until skeletal maturation is achieved or when the skeleton is challenged to repair an injury.

Thus, in an exemplary embodiment the invention provides a system to obtain the maximum information from these knockout mice for their effect on skeletal development, and on the maturation and maintenance of skeletal structures during the adult years. Furthermore the process can be accomplished at a cost and time line that is reasonable. The system focuses on abnormalities affecting bone or cartilage that either promote or detract from the acquisition of adult bone mass and the formation of a growth plate that contributes to coordinated linear growth. Already there are many genetic elements that are known to interfere with the chondrocyte proliferation and maturation of the growth plate as well as genes that interfere with new bone formation or enhance bone degradation. In some cases the phenotype is only evident when both alleles are inactivated but in others the defect is so significant that haploid insufficiency results in a detectable abnormality. Recessive mutations that are embryonic or perinatal lethal and do not have an apparent effect on the skeleton need to be screened in their heterozygous state as they too may have a quantitative effect on cartilage or bone biology.

For a catalog of genes affecting cartilage and bone to be useful, it will have to be performed in a consistent manner that captures both qualitative features that can be observed as an image and as a quantitative representation of these images that can assess the relative impact of the mutation on a specific aspect of the biology. Ideally the skeletal phenotyping data should be in a digital format and organized in a structure database that can be queried by the skeletal biology community. The present invention provides a system for making these types of measurements.

Morphologic and quantitative traits for bone and cartilage. While x-rays, DEXA and microCT can all provide useful information about the architectural details of bone and cartilage, they do not reveal the biological dynamics that underlie these morphological findings. Knowing the cellular basis of the genetic effect is essential for interpreting quantitative traits. The rate that progenitors are expanding in number, progressing to full maturation and then removed and replaced by another cycle of formation is basic to each system.

Quantitative histomorphometry of bone can assess static structural features, rates of mineral acquisition and bone formation and sites of active remodeling. These measurements indicate whether a deficiency in bone mass is secondary to decreased formation or increased resorption. A similar relationship is observed in high bone mass states as either high formation or reduced resorption. A relatively normal bone mass can be observed when high bone formation is able to compensate for a high resorption rate (high turnover). Each dynamic measurement implies a functional abnormality in either the osteoblasts or osteoclasts lineage by genes that affect their differentiation and/or function. For growth plate cartilage a similar dynamic state of proliferation, differentiation and ultimate apoptosis of hypertrophic cells as well as morphologic cellular features are used to characterize the response of growth plate to radiation or genetic maladies. These measurements are not as firmly established or widely practiced as bone histomorphometry and would need more attention before it was used as a phenotyping tool. The problem with both of these assessment tools for skeletal morphology is the labor-intensive nature for generating histological sections and the manual analyzing steps needed to generate quantitative information. In short they are not high throughput low-cost screening platforms that can easily distinguish a variant of normal that would subsequently require more detailed analysis.

In another aspect, the invention provides GFP reporter mice as surrogates for cells within the adult mouse skeleton and during that time we have come to appreciate the power of fluorescence-based microscope imaging of skeletal tissues. Key to the new histology is the ability to section frozen non-decalcified skeletal structures from adult animals using a tape transfer process that preserves the morphological features that are lost in traditional frozen sections. There are many advantages of this sectioning technique over the traditional methods of paraffin or methyl-methacrylate histology, including processing speed, consistency of section morphology, high signal to noise, and automation.

Processing speed. As soon as a tissue is fixed in paraformaldehyde (two to three days), it can be trimmed, embedded in OCT, and sectioned all in one day as opposed to multiple days of tissue dehydration and equilibration with the embedding media.

Consistency of section morphology. The tape transfer step consistently produces full-length long bone sections that are not fragmented or distorted as can occur when sections are floated and captured on a slide.

Low auto fluorescence background of the frozen sections, which is negligible compared to the other embedding media. This feature allows for bright sharp mineralization lines to be maintained, particularly those in the red spectrum. Enzymatic activity and immunohistochemistry is also much more strongly preserved in the frozen sections and permits clear detection of fluorescence signals from the background.

Observer-independent, computer-defined identification of tissue morphology, cell types and dynamic activity based on the defined fluorescent signals generated by the histology. For example, the mineralized tissue is detected either in bright field or in fluorescence when stained with calcein blue. Once the mineralized structures have been identified, cellular and metabolic activity is related to the bone surface. Mineralization dyes such as tetracycline, alizarin red complexone or calcein administered two and seven days prior to sacrifice can be mapped to the bone surface to indicate regions undergoing active mineralization at the time the dyes were administered. Individual cells can be identified in fluorescence with a DAPI stain and identified as osteocytes if they are contained within the mineralized region of bone. Tartrate resistance acid phosphatase (TRAP) positive cells can be identified with a fluorescence based substrate (ELF97) while alkaline phosphatase positives cells can be distinguished with a different fluorescent substrate (fast red). Thus these fluorescence signals can identify the bone surface that is undergoing active resorption or new formation based on cell specific stain (TRAP or AP) and whether or not the underlying bone surface is undergoing active mineralization.

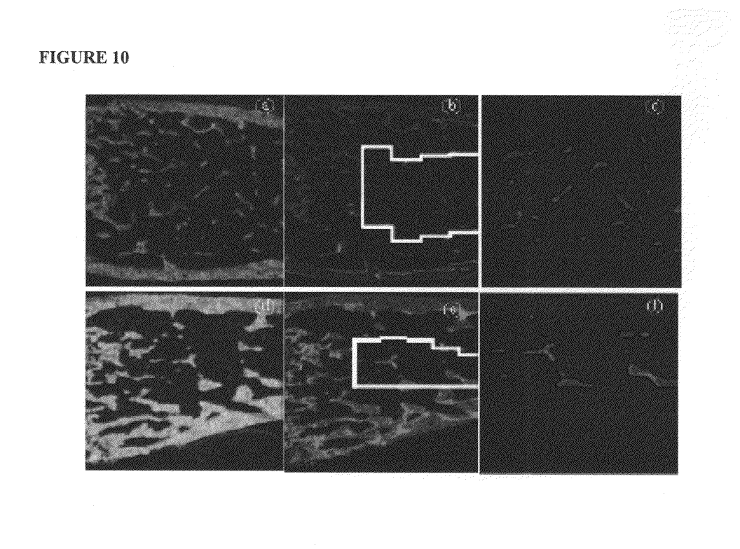

Computer algorithms to threshold, measure and compute static and dynamic histomorphometry from the raw fluorescence images. Using modern computer controlled microscope platforms, tiled images of the entire region of interest of bone are captured for each fluorescence signal to generate a stack of image files that can be registered one upon the other for the computer to image process and compute the traditional dynamic and histological measurements. Thus the algorithms define the region of interest, compute the bone volume, trabecular number and thickness within this region of interest, calculate the matrix acquisition rate and bone formation rate from the mineralization line data, determine the percentage of bone surface undergoing active resorption and surfaces lined by bone forming versus non-forming osteogenic cells and compute the osteocyte density within the cortical bone. Comprehensive tables of measured and calculated values with statistical comparisons are generated by the program (see FIG. 10 and Table 3). All of this is done with minimal human intervention within minutes after the completed set of image files are submitted to the computer program.

We purchased 6 male and 6 female C57BL/6 mice and the same numbers of C3H male and female mice from Jackson Labs, and aged to 3.5 months and injected them with calcein 7 days and AC 2 days prior to sacrifice. Samples were processed for cryosectioning using the tape transfer step, and the unstained and nondecalcified sections were imaged by DIC, green and red fluorescence. The tiled distal femur was selected for analysis using a computer-selected ROI that was 400 μm from the growth plate including about 1.215 mm2. FIGS. 10(a) and 10(d) are, respectively, two example scanned images of C57BL/6 and C3H female mice. FIGS. 10(b) and 10(e) are computer selected ROIs. FIGS. 10(c) and 10(f) show the automated segmentation outcome of ROIs presented in pseudo colors.

Table 5 shows the summary of primary measurements of a labeled surface relative to the total mineralized surface within the ROI.

sLS/BS—single labeled surface over bone surface; dLS/BS—double labeled surface over bone surface; LS/BS—labeled surface over bone surface which is the summation of double labeled surface and single labeled surface; MS/BS—mineralizing surface over bone surface and is calculated (dLS+sLS/2)/BS; MAR—mineral apposition rate is measured as the distance (μm) between the two mineralization lines divided by the interval between labeling; BFR—Bone formation rate is calculated as MAR×(MS/BS).

TABLE 3

| | | | [symbol] | [symbol] | [symbol] | [symbol] | [symbol] | [symbol] | [symbol] | [symbol] |
|---|---|---|---|---|---|---|---|---|---|---|
| B6 | Female | 1 | 30.31 | 11.74 | 42.05 | [symbol] | 1.17 | 31.58 | 3.45 | 19.63 |
| | | 2 | 28.11 | 15.01 | 43.11 | 29.06 | 1.04 | 30.28 | 6.06 | 17.11 |
| | | 3 | [symbol] | 4.65 | [symbol] | 16.77 | 1.20 | 22.53 | 3.52 | 17.72 |
| | | 4 | 34.91 | 0.00 | [symbol] | 17.45 | NaN2 | NaN2 | 7.53 | 18.08 |
| | | 5 | 34.59 | 23.12 | 57.71 | [symbol] | 1.12 | 45.43 | 8.58 | [symbol] |
| | | 6 | 39.40 | 12.86 | 52.25 | 32.56 | 1.07 | 34.87 | [symbol] | 16.26 |
| | | mean | 32.13 | 13.48 | 45.60 | 29.54 | 1.12 | 32.94 | 5.72 | 17.84 |
| | | std | 4.84 | [symbol] | [symbol] | 7.92 | 0.07 | [symbol] | [symbol] | 1.29 |
| | Male | 7 | 35.52 | 5.54 | [symbol] | [symbol] | 1.08 | 25.06 | [symbol] | 33.63 |
| | | 8 | 28.07 | 8.53 | 36.60 | 22.57 | 0.73 | 16.57 | 12.09 | 22.02 |
| | | 9 | 29.18 | 7.43 | [symbol] | 22.02 | 1.00 | 22.05 | [symbol] | [symbol] |
| | | 10 | 26.83 | 8.20 | 35.02 | 21.61 | 0.92 | [symbol] | 13.35 | 24.12 |
| | | 11 | 37.18 | 13.70 | 50.87 | 32.28 | 0.71 | 22.87 | 10.50 | 23.43 |
| | | 12 | 25.35 | 8.49 | 33.84 | 21.16 | 1.00 | 21.26 | 7.64 | [symbol] |
| | | mean | 30.35 | 8.65 | 39.00 | 23.82 | 0.91 | 21.27 | 12.21 | 24.70 |
| | | std | 4.84 | 2.72 | 6.31 | 4.21 | 0.15 | 2.89 | 2.76 | 4.97 |
| | | mean | 31.16 | 10.84 | 42.00 | 26.42 | 1.00 | 26.57 | 9.26 | 21.58 |
| | | std | 4.63 | 5.26 | [symbol] | 6.55 | [symbol] | 8.30 | 4.16 | [symbol] |
| C3H | Female | 1 | 33.82 | 17.96 | [symbol] | 34.90 | 0.87 | 30.36 | 10.77 | 18.92 |
| | | 2 | 33.78 | [symbol] | 56.14 | 39.25 | 0.79 | [symbol] | 23.11 | 48.70 |
| | | 3 | [symbol] | 14.42 | 45.97 | [symbol] | 1.36 | 40.85 | 14.60 | 29.15 |
| | | 4 | 24.15 | 15.53 | 39.78 | 27.71 | 0.93 | 25.71 | 17.94 | 30.30 |
| | | 5 | 27.21 | 16.25 | 45.46 | 31.66 | 0.98 | 31.22 | [symbol] | 28.53 |
| | | 6 | 40.05 | 14.66 | 54.91 | 34.69 | 1.23 | 42.97 | 20.39 | [symbol] |
| | | mean | 31.74 | 17.25 | 49.00 | 33.12 | 1.03 | 33.67 | 16.07 | 31.89 |
| | | std | [symbol] | 2.97 | 6.34 | 4.09 | 0.22 | [symbol] | 5.38 | 9.54 |
| | Male | 7 | 26.34 | 7.54 | [symbol] | 20.71 | 1.42 | 29.36 | 14.86 | 31.58 |
| | | 8 | 41.46 | 12.09 | 53.55 | 32.52 | 0.74 | 24.26 | 15.77 | 33.78 |
| | | 9 | 21.75 | 0.00 | 21.75 | 10.66 | NaN2 | NaN2 | 12.31 | [symbol] |
| | | 10 | 31.69 | [symbol] | 46.90 | 31.06 | 1.22 | 37.93 | [symbol] | 49.48 |
| | | 11 | 26.55 | 19.26 | 45.32 | 32.54 | 0.95 | 31.01 | 6.98 | 18.94 |
| | | 12 | 27.37 | 12.12 | 39.49 | 25.60 | 0.85 | 21.89 | 13.60 | 27.34 |
| | | mean | 30.68 | 13.25 | 43.93 | 28.59 | 1.04 | 28.89 | 15.00 | 32.23 |
| | | std | 6.40 | 4.33 | 7.51 | 5.23 | 0.28 | 6.26 | 6.01 | 11.19 |
| | | mean | 31.26 | 15.43 | 46.69 | 31.06 | 1.03 | 31.50 | 15.59 | 32.04 |
| | | std | [symbol] | 4.04 | 7.05 | 4.69 | 0.24 | 5.67 | 5.40 | 9.78 |

| | | | | | | | | |
|---|---|---|---|---|---|---|---|---|
| t-test p-values | | | | | | | | |
| B6 Female vs. B6 male | 0.2604 | [symbol] | 0.1160 | 0.0968 | [symbol] | 0.0160 | [symbol] | [symbol] |
| C3H Female vs. C3H male | [symbol] | 0.0520 | 0.1334 | 0.0776 | 0.4766 | 0.1270 | 0.3827 | [symbol] |
| B6 vs. Ch3 | [symbol] | 0.0168 | [symbol] | 0.0387 | 0.3775 | 0.0709 | 0.0031 | 0.0033 |

[symbol]

indicates data missing or illegible when filed

The net effect of this new system for bone histomorphometry is reduced time to generate calculated results (two weeks versus eight weeks), significantly less personnel costs, consistency of analytical data since there is no observer variability or bias introduced into the data gathering, and documentation of all calculated values because the computer saves and can retrieve all the steps that led into a calculated value. The technical variation between three replicates samples from one bone is approximately 5% while the biological variance between animals is approximately 15%. The power analysis suggests that we can detect an approximately 30% difference in a morphometric measurement with about 80% confidence in six mice and a dynamic measurement of about 30% in three mice.

The Tables below show a typical full dataset for dynamic and static histomorphometry for the femur in an 8 mice per group analysis that contrasts C57Bl/6 male and female mice at 16 weeks of age (Table 6). A summary of a complete study of male and female mice at age 8 and 16 weeks of age for static, dynamic (Table 7) and cellular (Table 8) histomorphometry of vertebral body in C57Bl/6 mice using this computer approach is presented.

It should be noted that the present system can be adapted for use with any suitable tissue, including, e.g., growth plate and/or articular cartilage. For example, in certain embodiments, the tissue is articular cartilage. In certain embodiments, the articular cartilage frozen sections are subsequently treated with chromogenic stains that identify cartilage tissue from the surrounding tissues. By stacking this image on top of the fluorescent images, it is possible to assess cellular density and morphometry of cartilage regions and to distinguish hypertrophic cells that are undergoing active mineralization. In still another embodiment, the animal is administered EdU prior to sacrifice, wherein the system allows the identification of actively proliferating chondrocytes. Thus the frozen histology of long bone is an efficient and effective screen for bone and cartilage abnormalities because they are captured all from a single section and the assessment is done through computer algorithms that perform the task in a rapid observer-independent manner.

Exemplary Model for Phenotyping Cartilage and Bone.

In another exemplary embodiment, the invention provides a system comprising a two-phase stratified workflow approach to identifying genes that impact the cartilage and bone skeleton. In certain embodiments, the first phase comprises a screening phase in which animals are identified that do not show a morphologic abnormality in, e.g., x-ray or DEXA screens. Mice that showed an abnormality at the screening phase or had obvious changes by x-ray or DEXA would receive the more comprehensive evaluation or second phase. All the recessive mutations as well as heterozygotes for a lethal homozygous dictation would be candidates for the evaluation phase.

For example, in an exemplary embodiment the program begins with known mutations that affect cartilage and bone biology against which new mutations are judged. The analysis is done at two different age groups. Animals at 6 weeks of age will emphasize the formation side of skeletal development and would be sensitive to mutations affecting growth plate morphology as well as new bone formation. Mice examined at 4 months of age will emphasize the ability of the skeletal system to maintain its architecture and would be sensitive to mechanisms that enhance destruction of the skeleton. Examining at these two stages contrasts forces that control modeling of the skeleton versus the forces that emphasize remodeling.

In an exemplary embodiment, the first phase or screening evaluation phase comprises three male and three female mice taken at age 6 weeks and 4 months of age that serve as the sample population. In certain embodiments, prior to initiating the analysis, a web interface page is completed by the submitting site to identify the mice, the underlying mutation, and birth/caging/injection details of each animal to be submitted. When the animals reached the appropriate age they receive a parenteral injection of calcein and alizarin red complexone 7 and 2 days prior to sacrifice. The legs (tibia and femur) are harvested, logged into the database and bar coded for sample identification and tracking. The tibia and femur are isolated for digital x-ray documentation of length and morphology. The femur is embedded in OCT and archived until both the 6-week and 4-month samples have been accumulated. The OCT embedding media appears to be the best way to maintain the quality of the bone for later sectioning. Once the sections from both age and sex groups have been acquired, 5μ sections are harvested at three different levels in the mid region of the bone. Thus, in this exemplary embodiment, a screening analysis set will consist of 12 slides each containing three sections per bone and three bones from each sex and each age group. The 12 slide sample sets are processed as one unit beginning with staining the sections with calcein blue and DAPI followed by scanning for the fluorescent signals of calcein blue (mineralized bone), calcein and alizarin red complexone (mineralization lines) and DAPI (cell nuclei).

In another embodiment of the system provided by the invention, the image files of these scanning signals is presented to an analysis pipeline which computes static and dynamic measures of bone architecture and formation, osteocyte cell density, morphology of the growth plate and the articular cartilage. In still another embodiment, the images supporting these measurements as well as summary data tables are deposited in a database, for example, the Jackson phenome database (phenome.jax.org) or other national resource database. In certain embodiments, the information is in digital format for subsequent mining and recall.

In the present example, the second phase or comprehensive evaluation phase includes—6 mice from each age group and sex will constitute the study group (24 samples). Besides receiving an injection of calcein and alizarin red complexone for mineralization measurements, mice that have a suspected abnormality of the growth plate receive an injection of EdU one day prior to sacrifice. Optionally, the spine or mandible is harvested as an example of axial and neural crest derived skeletal tissue. The analysis is performed on the distal femur, growth plate and articular cartilage. In addition to the digital x-ray assessment of the femur and tibia, the static and dynamic bone morphology and chondrocytes morphology discussed in the screening evaluation (although now with twice the number of samples), the sections is further processed for TRAP and AP staining.

These steps produce signals that are mapped to the bone surface and are surrogates for osteoclasts and cells within the osteogenic lineage that may or may not be actively forming new bone mineral. In the case where the animal was administered EdU, particularly animals at six weeks of age, identifying actively proliferating chondrocytes within the growth plate and articular cartilage is possible.

Finally, the sections are incubated with one or more chromogenic stains that identify cartilage and bone matrix. In certain embodiments, all of these steps are performed on the same section and are superimposed with the use of registration beads that are placed adjacent to the sections. Thus in addition to the dynamic and static histometric measures, the presence of osteoclasts both on the bone surface and within the cartilage matrix can be identified and measured. Similarly cells of the osteogenic lineage within bone can be identified and measured.

EdU labeling provides a cartilage proliferation rate and is useful for identifying a labeling rate of cells in the osteogenic lineage. The chromogenic stain provides a basis for measuring the thickness of non-mineralized osteoid as well as adipocytes in the bone marrow. All of these measurements are digitally documented and tables are generated of individual and group data. In certain additional embodiments, the database includes an appropriate reference population against which statistical tests can be made for the relevance of a particular measurement. All of this information is stored within a database as discussed above for query and viewing. In addition to the information that is deposited within the database, the non-dissected skeletal tissues will be available for further study by investigators.

Baseline histomorphometry for C57Bl/6 comparing male and female mice at 16 weeks (Table 4) illustrates the extent of the data that is collected from an exemplary 8 mouse comparison study. A complete comparative study done on vertebra is presented as summarized data. The measurements are made between male and female mice at two age groups. Table 5 presents the static and dynamic measurements and demonstrates the very high rate of bone formation yet lower bone mass in the female animals at both ages. This difference is apparent in the TRAP and AP cellular measurements (Table 6). Female mice have a higher number of bone forming AP cells (AP over red label) while males have a higher level of AP inactive cells. Similarly, female mice have higher osteoclast activity at both ages. However with age the bone formation rate and osteoblast activity diminishes. It is this dimorphic and age/maturation related difference in bone turnover that underlies our proposal for phenotyping in both sexes during the later stages of skeletal growth and after skeletal maturation is achieved. The entire process can be repeated on a new set of mice using identical methodology to ensure that we have a consistent baseline dataset.

Abbreviations of the Column Headers:

Dynamic Measurements: R/BS=total red label (alizarine red complexone) per trabecular bone surface. Usually the last label; G/BS=total green label (calcein) per trabecular bone surface. Usually the first label, 5-7 days before the second; R_only/BS=red label alone (single label); G_only/BS=green label alone (single label); sLS/BS=single labeled surfaces (green or red); dLS/BS=double labeled surfaces; LS/BS=label surfaces (single and double); MS/BS=mineralizing surfaces; calculated value of double surfaces plus 1/2 of single; sLS/LS=proportion of labeling surfaces that are single; dLS/LS=propostion of labeling surface that are double; dLS/sLS=ratio of double to single labeled surface; MAR(um)=interlabel distance divided by the day interval between the labeling (usually 5 days); BFR=calculate value of the MAR×MS/BS.

Static Measurements: BV/TV=summated area of mineralized bone within the selected region of interest (ROI); Tb·Th=average area of the trabecular within the ROI; Tb·N=number of trabecular islands within the ROI; Tb·Sp=average area within the ROI that exists between each trabecular island;

TABLE 7
Summation of static and dynamic histomorphometry data of vertebra
between 8 and 16 week old male and female mice in the C57B16 background.

| [symbol] | | | [symbol] | [symbol] | [symbol] | [symbol] | [symbol] | [symbol] | [symbol] | [symbol] | [symbol] |
|---|---|---|---|---|---|---|---|---|---|---|---|
| 8 weeks | Male | mean | [symbol] | 13.48 | [symbol] | [symbol] | 31.74 | 5.34 | 42.03 | [symbol] | [symbol] |
| | | std | [symbol] | [symbol] | [symbol] | [symbol] | [symbol] | [symbol] | [symbol] | [symbol] | [symbol] |
| | Female | mean | [symbol] | 23.78 | 34.15 | [symbol] | 44.78 | 13.17 | 57.93 | 35.55 | 77.39 |
| | | std | [symbol] | [symbol] | [symbol] | [symbol] | [symbol] | [symbol] | [symbol] | [symbol] | [symbol] |
| | p-value | | [symbol] | [symbol] | [symbol] | [symbol] | [symbol] | [symbol] | [symbol] | [symbol] | [symbol] |
| 16 weeks | Male | mean | 24.18 | [symbol] | 21.14 | [symbol] | [symbol] | 2.95 | 34.23 | 18.62 | 92.11 |
| | | std | [symbol] | [symbol] | [symbol] | 7.61 | [symbol] | [symbol] | [symbol] | [symbol] | [symbol] |
| | Female | mean | 15.42 | 19.43 | 28.21 | 12.22 | 43.43 | 7.21 | 47.64 | 27.42 | 85.07 |
| | | std | [symbol] | [symbol] | [symbol] | [symbol] | [symbol] | [symbol] | [symbol] | [symbol] | [symbol] |
| | p-value | | [symbol] | [symbol] | [symbol] | [symbol] | [symbol] | [symbol] | [symbol] | [symbol] | [symbol] |
| [symbol] | | | | [symbol] | [symbol] | [symbol] | [symbol] | [symbol] | [symbol] | [symbol] | |
| 8 weeks | Male | mean | 11.83 | 13.71 | [symbol] | [symbol] | 20.33 | [symbol] | 3.47 | 237.74 | |
| | | std | [symbol] | [symbol] | [symbol] | [symbol] | [symbol] | [symbol] | [symbol] | [symbol] | |
| | Female | mean | 22.61 | 29.52 | 1.44 | 51.12 | 16.15 | 47.56 | 3.43 | 248.24 | |
| | | std | [symbol] | [symbol] | [symbol] | [symbol] | [symbol] | [symbol] | [symbol] | [symbol] | |
| | p-value | | [symbol] | [symbol] | [symbol] | [symbol] | [symbol] | [symbol] | [symbol] | [symbol] | |
| 16 weeks | Male | mean | 7.60 | 6.74 | 0.86 | 15.82 | 14.60 | 41.17 | 3.83 | 242.71 | |
| | | std | [symbol] | [symbol] | [symbol] | [symbol] | [symbol] | [symbol] | [symbol] | [symbol] | |
| | Female | mean | 14.93 | 17.66 | 1.15 | 32.24 | 11.53 | 41.65 | 2.81 | 125.42 | |
| | | std | [symbol] | [symbol] | 0.21 | [symbol] | [symbol] | [symbol] | [symbol] | [symbol] | |
| | p-value | | [symbol] | [symbol] | [symbol] | [symbol] | [symbol] | [symbol] | [symbol] | [symbol] | |

Note that BFR is twice as high in female than male mice and that the BRF falls by about 40% between 8 and 16 weeks of age. BV/TV reflects the dimished bone mass of the female animals and the generalized decreased bone mass with maturity. [symbol]
indicates data missing or illegible when filed

TABLE 8
Summation of TRAP and AP cellular histomorphometry data between 8 and
16 week old male and female mice in the C57B16 background.
This analysis was performed on vertebral bone.

| BL6_V | | | AP/BS | AP_R/BS | AP_only/BS | TRAP/BS | TRAP_R/BS | TRAP_only/BS | TRAP_on/TRAP | TRAP/TV |
|---|---|---|---|---|---|---|---|---|---|---|
| 8 | Male | mean | 67.31 | 22.13 | 34.70 | 8.97 | 3.77 | 4.45 | 88.10 | 0.52 |
| weeks | | std | 10.23 | 6.93 | 4.30 | 4.62 | 2.11 | 2.25 | 6.75 | 0.29 |
| | Female | mean | 78.01 | 29.60 | 28.25 | 12.63 | 4.77 | 5.32 | 81.26 | 0.69 |
| | | std | 3.39 | 3.10 | 3.01 | 4.99 | 1.98 | 2.09 | 9.68 | 0.26 |
| | p-value | | | | | | 1.08E−01 | 2.44E−01 | | |
| 16 | Male | mean | 66.57 | 16.76 | 39.48 | 9.45 | 3.39 | 5.24 | 83.24 | 0.56 |
| weeks | | std | 8.83 | 5.43 | 3.97 | 4.18 | 1.46 | 2.94 | 7.59 | 0.43 |
| | Female | mean | 72.04 | 25.10 | 31.93 | 16.11 | 5.77 | 7.54 | 81.54 | 0.71 |
| | | std | 7.86 | 4.82 | 3.10 | 3.04 | 1.73 | 1.62 | 6.49 | 0.15 |
| | p-value | | 5.42E−01 | | | | | | 4.97E−01 | |

Note that the female mice have higher AP/BS than the males, while the males have the higher APonly.
TRAP is high in females for all measurements except TRAP_on/TRAP.

Abbreviations Used in the Columns:

AP/BS=Total AP labeling per bone surface; AP_R/BS=AP labeling associated with the most recent mineralizing surface (active osteoblasts); AP_only/BS=AP not associated with the most recent mineralizing surface (inactive osteoblasts or lining cells); TRAP/BS=ELF97 positive activity per bone surface; TRAP_R/BS=ELF97 positive activity that maps to the bone surface containing the most recent mineralization activity (may indicate an area undergoing active remodeling); TRAP_only/BS==ELF97 positive activity on bone surface devoid of mineralizing activity (may represent an erosion region); TRAP_on/TRAP=ELF97 positive activity that is mapped to bone relative to the total activity in the ROI; This measurement estimates the level of TRAP that is seen in the marrow away from a bone surface; TRAP/TV=Total ELF97 positive activity within the ROI.

The analysis shows that the C57BL/6 females have a high bone formation rate but lower total bone volume relative to the males, while the C3H females have a marginally increased bone formation rate and equivalent total bone volume relative to males. When compared across the two lines of mice, there is an equivalent and higher BFR in the females and the difference in BFR across the two lines reflect the difference in males. These comparisons and others that can be made from the table is very similar to those that have been published using manual techniques [Sheng et al, 1999; Akhter et al. 2000; Klein et al. 2002; Sheng et al. 2002] and gives us confidence that our thresholding and computational algorithms are reliable. Further details of power analysis are presented in Section F Vertebrate Animals. Finally, we found in this pilot study that it took about 15 minutes to produce the histological section, another 15 minutes to generate one image file and 1 minute to analyze one image file. We expect the speed, accuracy and efficiency of our proposed automated analysis would become far greater, once our approach is refined and used in high-throughput settings. Our goal is to embed, section, image a complete 12 bone set (6 test and 6 controls) in one day and transfer the file data for analysis in the evening so that an automated report with representative images can be posted by the next morning.

The present invention demonstrates that it is possible to develop a rapid, yet comprehensive automated way of processing tissue, e.g., bone, histomorphometry. Therefore, the systems and methods can serve as a high throughput mechanism for evaluating all the genetically modified mice for evidence of altered bone structure and observing the change in bone architecture.

Described below is a detailed example of an embodiment of the system and methods provided by the invention.

i) Labeling mice and harvesting tissue—Using non-transgenic CD1 mice at 4 months of age, a group of 6 mice will be labeled with xylenol orange (XO, 90 μg/kg of 30 mgl/ml xylenol orange (Sigma X-0127)) at 7 days and calcein (30 μg/g of 3 mg/ml calcein (Sigma C-0875)) at 2 day prior to sacrifice. The spine and femurs will be removed and the nonadherent muscle and connective tissues removed from the bone without scraping the periosteal surfaces. The samples will be placed in 10% neutralized formaldelyde (Sigma) at 4° for 2-3 days with slow agitation.

ii) Bone morphometry—The dissected intact lower limb and spine will be imaged using the Faxitron MX-20 digital X-ray system using a phantom to standardize bone density. The digital image can be processed by the software for bone length measurement, and the image and computed measurements are saved for later recall.

iii) μCT analysis—The bone will be removed from the formalin, rinsed in PBS, drained and enclosed in saran wrap to keep the sample moist while it is placed in a Scanco μCT40 scanner of the distal metaphysis and the 5 vertebral body. The sample is stable in this moist environment at 4° for a number of weeks. Standard cortical and trabecular bone volume measurements as well as representative reconstructed images will be saved for later recall.

iv) Embedding and sectioning—One femur and spine are embedded in 30% sucrose (Frozen Embedding Medium, Thermo Shandon, Pittsburgh, Pa.) and frozen over methylbutane chilled in dry ice. The following day, the blocks are trimmed and sectioned using the Leica 3400 cryostat and the tape by Cryofilm IIC(10), Finetec Co., Ltd, Japan. It takes about 15 minutes to produce two slides with 2-4 sections per slide. Multiple sections are taken throughout the block and checked by a light microscope to position the section of the femur to include the central vein and a mid region of the vertebral body that includes the 5 vertebral. Once the tape is deposited on the slide, the section is allowed to reach room temperature. However, the sections and the remaining tissue block and other femur will be maintained at −20° for longer term storage.

v) Staining for osteoblast prior to imaging—Currently we are using neutral AP staining conditions and the fluorescent substrate fast red. We incubate for 5 min and terminate the reaction by rinsing. Because the enzymatic activity is so strong in these sections, we will continue to optimize the conditions to eliminate non-specific staining. Subsequently, the section is stained with DAPI. Both steps are done in a batch mode.

vi) Imaging the mineralized section—Using a 5× objective, sufficient resolution and fast imaging time can be accomplished so that a region of interest can be recorded within a few minutes. The distal metaphyseal region of the femur can be imaged with a 4×3 matrix, while the body of the vertebra is contained within a 2×2 matrix. The limits of each matrix is determined by the microscope operator and the computer is instructed to take a series of 4 images per field (DIC, green, red, sapphire and DAPI) to capture the mineral, calcein, XO, cell nuclear and AP stain. The stacks of images are labeled with the sample number and a composite image is generated as a pictorial representation of the bone.

vii) Imaging for osteoclasts—The TRAP stain is essentially an AP stain done under acidic conditions using the fluorescent stain ELF-97. The acid rapidly removes the fluorescent labeling lines and most of the mineral within the bone section. The section is subsequently stained with light green (exposed collagens) and counter stained with eosin (dark nuclei), stains that do not require dehydration, thus avoiding tissue shrinkage. The section is re-imaged using a color camera (sapphire for ELF-97, light for bone collagen and cell nuclei) using the same matrix configuration as the previous imaging. Alignment will be based on the shape of the stained bone matrix aligning with the mineralized matrix, while the color image will provide familiarity of the section to the observer.

Image Analysis of Bone

In this example, our image analysis is guided by addressing the six key issues given below. It is important to note that depending on which instrument and/or methods are used, the specifics of analysis steps may vary and are expressly encompassed by the invention. Any number of alterations and modifications of the systems and methods provided by the invention would be recognized by the skilled artisan in view of the present description. Moreover, the creation of any number variations would require no more than routine experimentation in view of the present description. One of the advantages of the present invention is that workflows are easily adjustable and reconfigurable to satisfy the changing requirements.

i) Image assembly—The first step is to assemble fractional images directly obtained from the microscope into a whole bone image. In certain embodiments, assembly may be performed using k-th law nonlinear correlation technique [Javidi et al, 1994] to stitch fractional images in a whole image. Image assembly will have to be done for both Von Kossa (VK) images and signal images. In the case of using DIC images instead VK images, one assembly would be sufficient.

ii) Overlaying signal image over Von Kossa DIC image—The next step is to fuse the stitched XO stained label image and the stitched DIC VK image in order to quantify the relationship of the XO stained label and GFP marked osteoblast over the bone surface. Again, assembly may be performed using k-th law nonlinear correlation to register the images and fuse them together as we found this method very satisfactory during our preliminary study. In fact, in an earlier study, we found that this k-th law nonlinear correlation method corrected numerous stitching mistakes made by the commercial software that is built-in to the microscope. If DIC is used instead VK images, overlaying would not be necessary.

iii) Smoothing surface—For various reasons, bone images suffer from ripped or broken surface areas. Treating these problem areas is needed as the area measurement should not be biased due to extra contouring of broken or ripped surface areas. The basic technique is filling or smoothing sharp concave regions while following the circumference of the bone image. In certain aspects, a median filter [Jain, 1989] is used, which can be applied to the binarized segmented VK (or DIC) image.

iv) Segmentation—Separating objects from the background in an image is referred to as segmentation. There are four popular approaches to segmentation: threshold techniques [Gonzalez, et al., 2002], edge-based methods [Shapiro, et al, 2001], region-based techniques [Shapiro, et al, 2001], and active contour model methods [Xu, et al, 1998]. In certain embodiments, the system/method applies a threshold technique because it can be applied to both bone and label/cell images. Unlike other techniques, it can be implemented without prior threshold criteria. Threshold techniques, which make decisions based on local pixel information, are effective when the intensity levels of the objects fall outside the range of levels in the background. Edge-based methods center around contour detection: their weakness in connecting together broken contour lines make them prone to failure in the presence of blurring. Usually, in a region-based method, the image is partitioned into connected regions by grouping neighboring pixels of similar intensity levels. Adjacent regions are then merged under some criterion involving perhaps homogeneity or sharpness of region boundaries. The main idea of active contour model is to start with some initial boundary shape represented in the form of spline curves, and iteratively modifies it by applying various shrink/expansion operations according to a certain energy function. Thresholding generates a binary image from a grayscale image such that objects of interest are represented as white pixels and other regions as black pixels. One of the thresholding techniques is Otsu's thresholding technique [Otsu, 1978]. It chooses a threshold to minimize the intraclass variance of the thresholded black and white pixels. The problem with thresholding is that it may not guarantee that the segmented pixels are continuous. In certain additional embodiments, image data is processed using Otsu's method, adaptive thresholding method, and local thresholding method.

v) Ratios computation—This step is needed to compute relationship between the tissue (e.g., bone) and labels. It can be achieved by trimming labels onto, e.g., the bone surface, using morphological image processing. Some stained labels or GFP marked osteoblast lines are located far from the surface of the bone. Even in a single segment of the label line or cell line, some parts are closely located to the bone surface and some are located far from the bone surface.

Therefore, it is difficult to find the bone surface corresponding to stained label or GFP marked osteoblast line. In order to find the precise ratios of the stained label (GFP marked osteoblast) over the bone surface, stained labels and GFP marked osteoblast need to be relocated on the surface of the bone surface. With morphological transformation applied to the stained label/GFP marked osteoblast lines, the stained label/GFP marked osteoblast lines of the leading edge can be trimmed and projected on the surface of the bone.

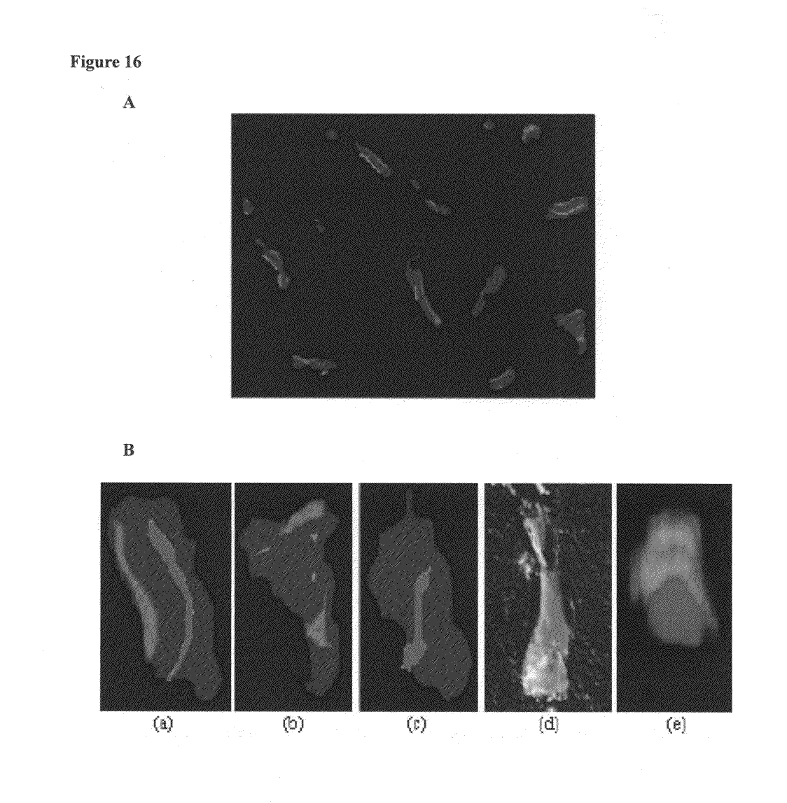

vi) Applying heuristic rules for quantification—In certain additional embodiments, quantification is performed using a series of heuristic rules designed to interpret relationships amongst recognized objects in 2D. For example, measuring cyan and red regions in FIG. 16(A) entails checking how two adjacent cyan or red regions are co-located (i.e., double label) within bone tissue. The general analysis rules to quantify the surface area of double labeling are as follows.

1. The leading edge of later injected label (hereafter red label) is determined by the average distance between the surface of the trabecula bone and the label. The shorter distance side of the label is the leading edge.

2. The leading edge of the first injected label (hereafter green label) is determined by one of either of the following two ways.

A. If the green label exists with the red label in the same trabecula bone and they are parallel, the closer side of the green label to the red label is the leading edge.

B. If green label is not in parallel with red label or it is not with the red label, the leading edge is determined by taking the average distance between the surface of the trabecula bone and the green label as in rule 1.

3. If green label and red label are in parallel to each other, the leading edge of the green label is projected onto the leading edge of the red label. The common regions of the red label and the projected green label are marked as double labeling. The remaining leading edges which are not covered with both labels are marked as single labeling.

4. The leading edges of label which are not parallel to each other are marked as single labeling.

5. If red label or green label is alone within the trabecula bone, leading edges of them are marked as single labeling.

6. The regions covered with the GFP cells are measured as their footprints on the surface of the trabecula bone.

7. Inter-label thickness is measured as follows. Distance between the surface of the trabecula bone and the green label is measured by projecting the green label onto the bone surface. The distance between the bone surface and the red label can also be measured in the same way. The inter-label thickness is the difference between the green label distance and the red label distance.

Additional rules might be useful in certain circumstances, which could be optimized by routine experimentation in the art in view of the instant description. In certain embodiments, the system/method of the invention includes image processing software using C/C++ and/or Java modules which can be easily repackaged into a configurable pipeline and that can be effectively interfaced with a database.

The present description provides methods and systems for quantifying histomorphometry image data, which is superior to previous archaic image processing methodologies, for example, stitching, in which multiple images were merely combined together. Typically, stitching processes are already included in modern microscope software packages as a routine procedure which combines multiple sectional images to create one because a microscope can see only small area of the slide. In contrast, the methods and systems described herein perform an image analysis step(s) that automatically or semi-automatically produces data (numbers), i.e., performs a quantification process designed to convert identified signals into numbers from the combined image.

Computer Implementation

Aspects of the invention may be implemented in hardware or software, or a combination of both. However, preferably, the algorithms and processes of the invention are implemented in one or more computer programs executing on programmable computers each comprising at least one processor, at least one data storage device (including volatile and non-volatile memory and/or storage elements), at least one input device, and at least one output device. Program code is applied to input data to perform the functions described herein and generate output information. The output information is applied to one or more output devices, in known fashion.

Each program may be implemented in any desired computer language (including machine, assembly, high level procedural, or object oriented programming languages) to communicate with a computer system. In any case, the language may be a compiled or interpreted language.

Each such computer program is preferably stored on a storage media or device (e.g., ROM, CD-ROM, tape, or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Exemplary systems and processes as provided by the invention (with reference to FIGS. 13-15).

With reference to FIG. 13(A), in an exemplary embodiment of a computer implemented system for performing histomorphometry imaging of a biological sample according to the methods described herein. The apparatus 10, also referred to as the system, comprises a microscope 12. In certain preferred embodiments, the microscope may further include, e.g., a camera, a light source, an image monitor, and at least one objective. The system 10 also comprises a computer processor 16 adapted to receive and process digitized images from the microscope 12. The computer subsystem further includes a computer monitor 14 and other external peripherals including storage device 18; controller, e.g., a telephone/internet connection 20, a pointing device, 22; a keyboard 24; and a printer 26. In certain embodiments the microscope may be connected to the processor 16, or directly to a storage device 18 or both. In certain embodiments, the storage device is a CD ROM or computer readable medium. In still other embodiments, the processor 16 may be configured to comprise a program that executes the processing of histomorphometry image data as described herein. In still additional embodiments, the system is adapted for the automatic imaging of a biological sample according to the methods described herein. Thus, in a preferred embodiment, the invention may be utilized for tissue analysis.

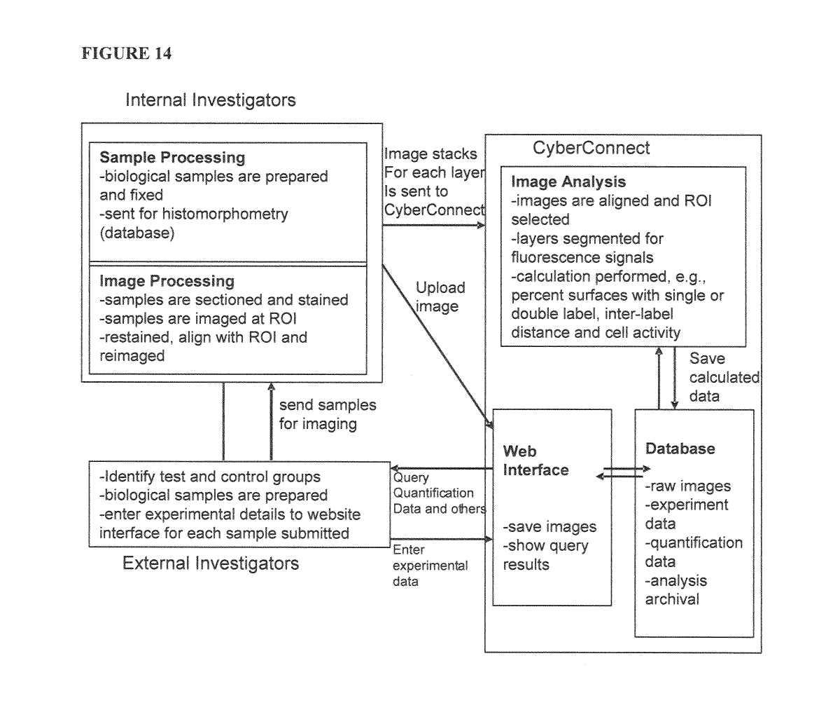

FIG. 14, described further below, illustrates how the various components of the system are inter-related. For example, it shows how the present invention allows three exemplary groups of participants, investigators, CyberConnect personnel, and outside investigators interact seamlessly through service arrangement, third party image analysis, real-time data analysis monitoring through Internet, and data base pipelines in a matter that is not presently available. Their respective activities will be explained in the context. As discussed herein, the invention provides a system and method to automatically quantify histomorphometry. The automated process will shorten the sample preparation time, which again contributes to reducing per image cost in histomorphometry.

Thus, the description provides a database and/or plurality of databases comprising tissue histomorphometry image data acquired according to the methods provided herein. Unless expressly indicated otherwise, the term “database” is used in an inclusive sense to refer to one or more databases. In an embodiment, the database comprises tissue histomorphometry image data taken from a plurality of tissues, and/or a plurality of organisms, and/or under a plurality of conditions, including normal; pathological or disease state; before, during, and/or after therapeutic treatment, and the like (i.e., “reference signature(s)”), derived using the methods provided herein. In additional embodiments, the database is comprised or stored on a storage device.

In an embodiment, the invention provides a computer-implemented method for performing tissue histomorphometry and/or creating a histomorphometry image data database comprising the steps of attaching a tissue sample to a transfer media, wherein the non-specimen side of the media is apposed to a slide using a non-fluoresent adhesive; providing a computer controlled microscope, a storage device, and at least one of a computer display, a processor, and/or a computer readable medium, wherein the processor or computer readable medium comprises a program for executing a histomorphometry imaging routine, as well as storing and processing image data; and defining at least one region of interest (ROI) on the slide using a microscope, wherein the microscope is in communication with the storage device; obtaining a series of images from the ROI, wherein the images are saved as data to the storage device; removing the slide from the microscope; and optionally, performing at least one staining protocol of the tissue attached to the slide; and reinserting the slide and reimaging the same ROI.

In still another embodiment, the invention provides a tissue histomorphometry imaging system comprising: an image acquisition means for acquiring image data of a region of interest (ROI); an image processing means configured to use model-based pattern recognition and/or morphological processing, and process the acquired image data from the ROI to generate a tiled image based on the acquired image data. In certain embodiments, the image acquisition means may comprise a microscope, e.g., a computer controlled microscope such a fluorescent, laser scanning or electron microscope. In certain additional embodiments, the image acquisition means may comprise or further comprise a storage device, which is in communication with a microscope. In still additional embodiments, the image acquisition means may comprise or further comprise a display, such as a computer display (i.e., monitor). In certain embodiments, the processing means is a processor or computer processor or computer server, which is in communication with one or more of the storage device, the microscope or both. In certain embodiments, the system may include a cell or tissue sample, e.g., apposed to a slide. In addition embodiments, the cell or tissue sample can be subjected to multiple staining protocols, and wherein the system is adapted to repeatedly image the same ROI from the tissue sample component. In a preferred embodiment, the tissue histomorphometry imaging system is fully or semi-automated.

In another aspect, the description provides a computer readable medium storing a program causing a computer to execute a process comprising at least one of inputting, storing, processing, querying, accessing, retrieving, displaying, analyzing, comparing, or combination thereof, and/or other functionality, of the histomorphometry image data acquired or input to the database according to the methods provided by the invention. In any of the embodiments described herein, the process can be adapted to execute a process allowing at least one of processing, querying, accessing, retrieving, displaying, analyzing, comparing or combination thereof, of histomorphometry image data stored in the database, and/or of real time image data.

In an additional aspect, the description provides a computer implemented histomorphometry system comprising a microscope and a storage device, wherein the microscope is in communication with the storage device such that histomorphometry image data acquired from a region of interest (ROI) of a tissue is stored to the storage device; and a processor in communication with at least one of the storage device, the microscope or both, wherein the processor is configured to use model-based pattern recognition and/or morphological processing sufficient to process the acquired image data from the ROI. In certain embodiments, the system may comprise a computer controlled microscope such a fluorescent, laser scanning or electron microscope. In still additional embodiments, the system may comprise a display, such as a computer display (i.e., monitor). In certain embodiments, the processor is a computer processor or computer server, which is in communication with one or more of the storage device, the microscope or both. In certain embodiments, the system may include a cell or tissue sample, e.g., apposed to a slide. In addition embodiments, the cell or tissue sample can be subjected to multiple staining protocols, and wherein the system is adapted to repeatedly image the same ROI from the tissue sample component. In a preferred embodiment, the tissue histomorphometry imaging system is fully or semi-automated.

In certain embodiments, the system also comprises a histomorphometry image data database as described herein. In certain embodiments, the system comprises a cell or tissue, e.g., apposed to a slide. In certain embodiments, the system also comprises a computer readable medium storing a program causing a computer to execute a process comprising at least one of inputting, storing, processing, querying, accessing, retrieving, displaying, analyzing, comparing, or combination thereof, and/or other functionality, of the histomorphometry image data acquired or input to the database according to the methods provided by the invention. In an additional embodiment, the system comprises a computer controlled microscope, e.g., a fluorescence, laser scanning or electron microscope, for acquiring and inputting histomorphometric image data. In any of the embodiments described herein, the system optionally includes a web-based user interface.

In any of embodiments of the computer implemented system or methods as described herein, the system can further be adapted to allow wireless communication allowing multiple users at other computer terminals to perform at least one of histomorphometry image data inputting, storing, processing, querying, accessing, retrieving, displaying, analyzing, and/or comparing the histomorphometry image data acquired.

The advantage of this invention over the conventional semi-automated quantification systems is that the new method is more conducive to improving the reproducibility and it could produce more precise and objective results in less time.

The disclosures have demonstrated the quality of the sections and the source of the tape. It has not discussed the workflow (multiple sections per slide) or automated imaging routines. In most cases the disclosure was incidental to the research topic being discussed usually as the necessary research methods section of a scientific presentation.

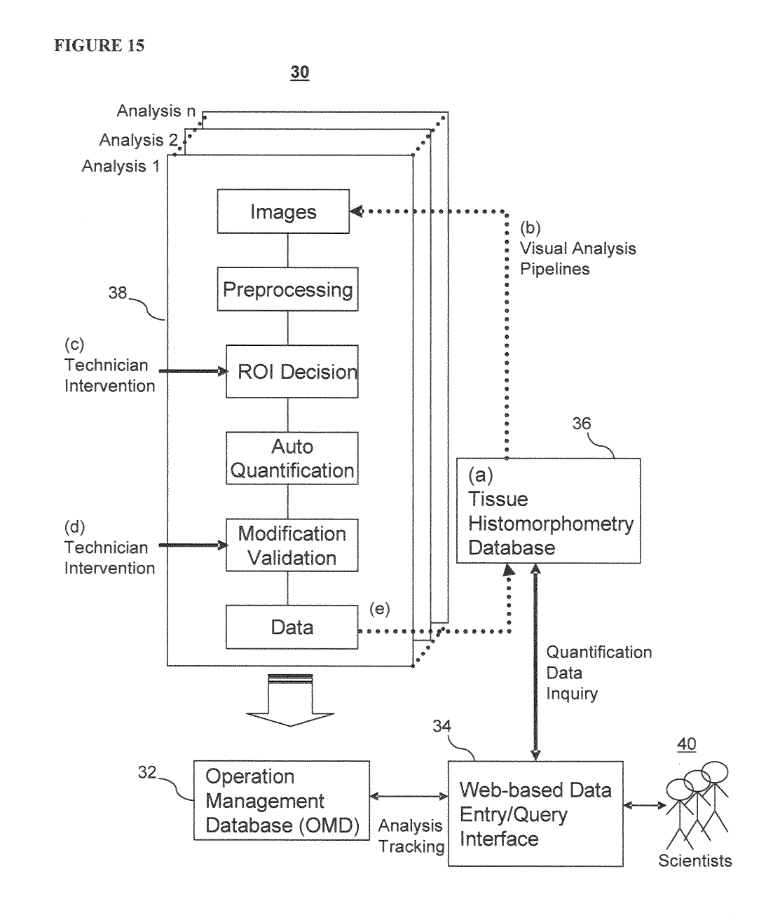

The variance by the described methods will be greatly reduced because many more measurements will be made and the consistency of thresholding the fluorescent signals will be better controlled. FIG. 15 summarizes an embodiment of a system provided by the invention. With reference to FIG. 15, the system/method 30 provided by this exemplary embodiment of the invention comprises a seamless operational model that maximally utilizes the automated quantification to establish a scalable high-throughput, low cost data analysis enterprise. For example, the scientist 40 uploads a set of images using a web-based interface 34, which can be further monitored and validated by internal personal. This web based interface also allows the user to annotate the image by entering the appropriate contextual information surrounding the image, e.g., sex, age, protocol used, etc. This contextual information is stored into the tissue histomorphometry database 36 along with the raw images and is maintained (FIG. 15(a)). Automated quantification of the uploaded image is initiated by launching the appropriate analysis pipeline (FIG. 15(b)). As shown in the example of FIG. 15, the analysis pipeline 38 involves human intervention in two steps, “ROI decision” FIG. 15(c)) and “Modification and Validation” (FIG. 15(d)). These two human intervention steps are discussed below shortly. The final outcome of the pipeline is the generation of the quantification data, which is automatically stored into the database 36 (FIG. 15(e)).

Two unique aspects of this operation are that (i) the analysis pipeline used in this operation are data flow (visual or non-visual) pipelines, and (ii) each instance of running the data flow (visual or non-visual) pipeline is persistently saved into a separate database, namely Operation Management Database 32 (OMD). OMD is useful and can be very handy to offer traceability of analysis for the scientists who need to examine or validate the quantification data.

In one exemplary embodiment, e.g., a bone histomorphometry database (BHD) system, the experiment annotation process may function as below:

(1) the experimental details such as genetic strain, sex, age, litter number and a unique sample number ID that will follow the sample through all the analytical steps, for example, entering experimental details of the mice test bed includes the use of, e.g., inbred mouse strains, C57BL/6, C3H, SJ129 (P3J), and the non-inbred strain CD1) as a test bed for developing and refining the operational model; (2) X-ray images of the long bone and spine plus physical measurements based on the X-ray image; (3) μCT derived static bone histomorphometry data including representative reconstructed images; and (4) dynamic histomorphometry measurements and representative images which are obtained from the above mentioned analysis pipeline including the following two additionally clarified steps:

i) Deciding region of interest (ROI)—Once the preprocessing step of image analysis is completed, the next step for the quantification computation is to determine ROI. The general rule for determining ROI for mouse femur is to find the trabeculae area which is located 400 μm below growth plate and 200˜400 μm inside of endosteal surface. During manual processing, the technician typically investigates multiple 200 μm×200 μm areas within trabeculae and measures signals and bone areas inside the squares as shown in FIG. 8(a). FIG. 8(b) illustrates that such a decision of ROI can also be automated. By selecting ROI using a computer, it is possible to obtain much mote sophisticated ROIs than those obtained manually by a technician using current software. However, in a very complex bone case determining ROI automatically may not be possible for many reasons such as broken bone, complex image (not necessarily femur), too complex growth plate, etc. We envision that although the decision of ROI can be done initially by the computer, in certain embodiments, the process may include a step of manual ROI verification or modification, if needed. This step is illustrated by FIG. 15(c). This ROI human intervention step will be written into a GUI program in Java, so that such user interaction can take place in the most intuitive way.

ii) Manual modification and validation—in certain embodiments, the system includes semi-automated quantification. For example, in the case of a BHD, some regions of the trabeculae could be too ambiguous or vague for an automated decision. FIG. 16(B) compares the cases which are straightforward (FIG. 16(B)(a)) and those which are problematic (FIG. 16(B)(b)-(e)). These are pseudo-colored trabecula images of a double labeled mouse femur. Blue represents segmented trabeculae from the bright field image (DIC), and magenta and cyan represent red and green labels, respectively. The red signals of FIG. 16(B)(b) and FIG. 16(B)(e) are too wide. In FIG. 16(B)(d) two red signals could have been conjoined. In FIG. 16(B)(c), the direction of bone growth that should be suggested by the green signal is ambiguous. That is, it is not clear whether the trabecula bone has grown from the middle to the left or from the middle to the right.

In certain embodiments, the system/method provides for or includes options for human intervention; for example, where (i) the technician entirely inspects the overall quality of quantification by focusing on every region of the image, and/or (ii) the computer tags problematic regions so that the technician can be alerted to pay attention to the tagged regions. It is expect that over 90% of the image would still be unambiguously processed. It will be only a small fraction that requires the final “touch-up”. Still the time saved by the automated portion will be enormous. During the touch-up phase, the technician will be able to manually trace the problematic regions and quantify. The total data combines both automated quantification and the touched-up quantification, and the final report will explicitly indicate which regions have been touched-up.

Exemplary Database Design

As illustrated in the exemplary database operational overviews of FIGS. 14 and 15, the database, a core part of the overall system framework, will store at least four sets of data.

i) Raw Images—The user's (scientist's) uploaded images through the web interface are saved along with their identification data such as experiment id, author, image type, date, etc. Images are stored as blobs.

ii) Experiment data—The user enters the contextual information surrounding the image that has been uploaded so that this experiment context can be queried together with the image itself as well as the quantification data that will be produced by the analysis pipeline.

iii) Quantification data—Each analysis produces a table of numeric numbers. These numeric quantification numbers are normalized into database tables so that they can be queried and also can be used to produce a paper form summary report.

iv) Analysis archival—each run of the analysis will be stored (i.e., analysis instance) persistently. The reason for the saving is primarily to support the analysis provenance. This issue is further discussed herein. One issue of saving these analysis instances would be the storage requirement, but we note that storage price is getting lower and the archived analysis instances would be periodically purged.

In certain aspects, PostgreSQL™ is utilized as the database management platform. It has several advantages including that it is an open source DBMS so that it can be easily package it into a bigger software framework, and amongst open source DBMS′; PostgreSQL™ is best at handling very large objects such as images.

Analysis Traceability and Analysis Provenance

The existing commercial, manual systems (e.g., Bioquant™, OsteoMeasure™) provide limited ways of saving how image tracing is carried out. The automated system/method provided by the present invention is configured to save the entire step-by-step analysis instance in an easy-to-retrieve manner. For example, each analysis instance can be saved into an XML document that includes not only the flow itself, but also all the intermediate files generated in all or some designated steps of the analysis. In many biological experiments, the desired outcome may only come after multiple trials, and until then the scientist should be able to examine what went wrong and his ability to examine the steps of analysis is critically important.

Web-Based User Interface

In certain embodiments, the system provided by the invention provides a web based user interface. In this embodiment, for example, the web user interface is the primary communication medium between users (i.e., scientists) and the computational environment (See also, FIGS. 15, 40 and 34). The user specifies what is needed and the interface presents the query results. The interface function that allows the user to upload the image and enter the specifics of the analysis is developed using standard, well known web technology. For the return of the analysis result, since this turnaround time is not instant, a few options exist. In certain embodiments, the web interface will have a notification and checkout feature that allows the user to retrieve the quantification data once that becomes available. For example, in an exemplary method the availability is proactively notified, e.g., through email or even a cell-phone text message. Upon receiving that notification, the user is able to check the web-interface and retrieve the quantification data. In another embodiment, no notification is provided, and the user periodically checks the web interface to see if the quantification data is available. Support for the analysis provenance means that from this web interface the user can check out the specific analysis instance. Using methods known in the art, a methodology can be developed that can freely deliver the analysis flows through the web.

The system and methods as described herein have many practical applications. For example, screening of agents for potential pharmacologic activity, identifying potential new therapeutics, diagnosing and/or monitoring the pathological state of a tissue.

In one aspect, the description provides a tissue histomorphometry method that can be used to screen potential therapeutic molecules from a “library” of compounds of unknown biological utility or effect. For example, in this method a database of high-confidence drug “reference signatures” are generated using histomorphometry image input derived from the methods described herein, from subjects and/or biological samples (i.e., cells or tissues) treated with a known a class of therapeutics. For example, using a mouse model, a database of signatures could be generated from one or more tissues in response to known drugs. Next, “test signatures” can be generated using histomorphometry image input derived from the methods described herein, from biological samples treated with a test compound from, e.g., a library of compounds. A comparison of the test signatures with reference signatures for many known drugs and drug classes provides an efficient method for identifying potentially useful therapeutic candidates as well as valuable information about the indication for which they might be most useful. In a related aspect the invention includes a statistical based algorithm suitable for performing comparisons between a test or unknown signature and the reference signatures contained in the database. This method of the invention, therefore, provides a means for reducing the time and cost of bringing novel therapeutics to market.

In another aspect the invention provides a computer database comprising tissue histomorphometry image “reference signatures” generated using the above method. Thus, in certain embodiments, the database comprises images from a plurality of tissues and/or organisms under a multitude of conditions, including, normal, various stages of pathological or disease state, various points in time during, e.g., a therapeutic regimen. In a related aspect the invention includes a statistical based algorithm suitable for performing comparisons between a test or unknown signature and the reference signatures contained in the database. For example, a computer algorithm could be used to analyze and compare regions of the reference signature and the test signature to determine the degree of statistical significance in identity of the response to the test signatures.

In a related aspect the invention provides methods for monitoring diseases, disease progression, and/or disease states in a subject. This aspect of the invention comprises the steps of generating a database of tissue histomorphometry image data “reference signatures” of normal, and disease tissues and disease states. Next, using the methods of the invention, a “test signature” is generated by performing the tissue histomorphometry imaging methods provided by the invention on a tissue whose pathological state is unknown or uncertain. Lastly, the test signature is compared to the database of reference signatures to diagnose the particular disease or disease state. In a related aspect the invention includes a statistical based algorithm suitable for performing comparisons between a test or unknown signature and the reference signatures contained in the database to diagnose specific conditions and diseases.

In a hypothetical example, the database comprises diagnostic reference signatures for normal bone tissue. Next, a test signature is generated using corresponding or analogous bone tissue from a patient. A comparison of the patient's test signature with the diagnostic signature database would then allow a health care worker to determine which, if any, pathological state the patient exhibits. A diagnosis of this type is particularly useful because it provides the health care worker with more specific information regarding disease state/progression, leading to more efficient treatment courses, and improving prognoses and overall clinical outcomes.

The present invention also provides methods for monitoring the efficacy or response of therapy upon a subject (i.e., performing pharmacogenomic studies). The methods involve comparing a test signature generated according to the methods described herein, obtained from a subject undergoing a particular therapy, with a database of reference signatures which are obtained from subjects whose response to a therapeutic is known. The detection and statistical analysis is performed as described herein. In a related aspect the invention includes a statistical based algorithm suitable for performing comparisons between a test or unknown signature and the reference signatures contained in the database. From this comparison a health care worker can tailor a treatment plan for a particular subject that will promote the most optimum clinical outcome possible.

The present invention also provides methods of identifying compounds with potential therapeutic utility. In an embodiment of this aspect, the method comprises the steps of using the methods described herein to generate a drug class reference signature database based on tissue histomorphometry image input from at least one subject treated with a drug of known utility. Then, generating a test signature from a second subject in response to treatment with a therapeutic agent of unidentified utility, and comparing the test signature to the drug class signature database, wherein a similar signature is indicative of a drug in the same class as that used to generate the reference signature.

Thus, in certain embodiments, the test signature may result from, e.g., the treatment of a tissue or subject with a known or unknown agent, from a subject suffering from a pathological disease or condition, or from an untreated or normal tissue or subject. The method includes a step of acquiring a test signature according to the methods described herein, querying the database with one or more test signatures; retrieving one or more stored reference signatures; and measuring or analyzing, quantitatively and/or qualitatively, a region of interest within at least one of the reference signatures and at least one of the test signatures, wherein the resulting histomorphometry image data comparison allows for the determination of the pharmacologic activity of an unknown agent, the diagnosis of a disease or condition, and/or the monitoring of a pathological state of a tissue or cell.

In an additional aspect, the invention provides a database comprising a collection of signatures generated according to any of the methods described herein.

It should be appreciated that the exemplary embodiments of the present invention should not be construed to be limited to the examples that are now described; rather, the exemplary embodiments of the present invention should be construed to include any and all applications provided herein and all variations within the skill of the ordinary artisan.

The contents of all references, patents, pending patent applications and published patents, cited throughout this application are hereby expressly incorporated by reference.

Those skilled in the art will recognize, or be able to ascertain using no more than routine experimentation, many equivalents to the specific embodiments of the invention described herein. Such equivalents are intended to be encompassed by the following claims.

It is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

1. A computer-implemented method for performing tissue histomorphometry comprising the steps:
attaching a tissue sample to a slide using a non-fluorescent adhesive;
providing a processor, a microscope, and a storage device;
defining at least one region of interest (ROI) on the slide using the microscope, wherein the microscope is in communication with the processor and storage device, and wherein the computer and storage device are adapted to store and process histomorphometry image data;
acquiring a first histomorphometry image from the at least one ROI, wherein the first image is stored by the storage device;
removing the slide from the microscope and performing at least one staining protocol of the tissue attached to the slide;
reinserting the slide and reimaging the at least one ROI to create a second image for each ROI;
overlaying the first and second images taken of each ROI to create an overlaid image; and
assembling the overlaid images for analysis.

2. The method of claim 1, wherein there are multiple sections per slide.

3. The method of claim 1, wherein the microscope is controlled by the processor.

4. The method of claim 1, wherein at the step of acquiring image data, a plurality or series of images are acquired and/or tiled.

5. The method of claim 1, wherein the images from each ROI are tiled.

6. (canceled)

7. The method of claim 1, wherein the at least one ROI is a single ROI and the method further comprises a step of comparing a plurality of the images taken that correspond to the same ROI, wherein a difference in the images of the respective ROI is indicative of a change in the tissue.

8. The method of claim 1, wherein the tissue is selected from the group consisting of bone, cartilage, and a soft tissue.

9. The method of claim 1, wherein the staining protocol comprises any of a chemical stain, an immuno- or antibody label, a fluorescent label, a metabolic indicator, a nucleic acid label, a peptide label, or a combination thereof.

10. A tissue histomorphometry imaging system comprising:
an image acquisition means for acquiring image data of a region of interest (ROI), comprising a microscope in communication with a storage device;
an image processing means for processing the acquired image data from the ROI using a model-based pattern recognition and/or morphological processing to generate a tiled image using the acquired image data, wherein: the acquired image data is a first image of the ROI overlaid upon a second image of the ROI; and the first image was taken before processing of the ROI and the second image was taken after processing of the ROI.

11. The tissue histomorphometry imaging system of claim 11, wherein the image acquisition means and image processing means are a computer and automated.

12. The tissue histomorphometry imaging system of claim 11, wherein the system includes a web based access component.

13. (canceled)

14. A tissue histomorphometry imaging system comprising:
a microscope and a storage device, wherein the microscope is in communication with the storage device such that histomorphometry images acquired from a region of interest (ROI) of a tissue is stored to the storage device; and
a processor in communication with at least one of the storage device, the microscope or both, wherein the processor uses model-based pattern recognition and/or morphological processing to process the acquired image data from the ROI,
wherein the histomorphometry images include an initial image of the ROI, a rescanned image of the ROI taken after staining the ROI, and an additional rescanned image of the ROI taken after a chromogenic staining of the ROI, and
the processing includes vertically stacking at least two of the initial image, the rescanned image and the additional rescanned image for inspection or analysis by a user.

15. A method for monitoring or diagnosing diseases, disease progression, and/or disease states in a subject comprising:
using the method of claim 1 to generate a reference signature database containing normal reference signatures based on tissue histomorphometry image input from a normal or healthy biological source and abnormal reference signature based on tissue histomorphometry image input from a biological source in an abnormal or diseased state;
using the method of claim 1 to generate a test signature database containing test signatures based on tissue histomorphometry image input from another biological source whose pathological or disease state is unknown; and
processing the reference and test signatures;
comparing one of the test signatures to the normal and abnormal reference signatures of the reference signature database;
determining whether a match exists between the test signature and one of the reference signatures, wherein a match with an abnormal reference signature is indicative of a pathological or disease state; and
diagnosing a pathological or disease state based on the matched abnormal reference signature.

16. The method of claim 15, wherein the histomorphometry image data is processed using model-based pattern recognition and/or morphological processing.

17. A method for monitoring the efficacy or response of a therapeutic regimen in a subject comprising:
using the method of claim 1 to generate a reference signature database including reference signatures using tissue histomorphometry image input from a normal or healthy biological source and a biological source during successful treatment with a therapeutic;
using the method of claim 1 to generate a test signature using tissue histomorphometry image input from a subject in response to known levels of the therapeutic;
processing the reference and test signatures; and
comparing the test signature to the reference signatures;
determining whether a change or a difference exists between the test signature and the reference signatures, wherein the change or the difference or a lack thereof is indicative of therapeutic efficacy or response; and
optimizing, maintaining or discontinuing the therapeutic for the subject based on the change or the difference or the lack thereof.

18. The method of claim 17, wherein the histomorphometry image data is processed using model-based pattern recognition and/or morphological processing.

19. A method of identifying a therapeutic molecule comprising:
using the method of claim 1 to generate a drug class reference signature database containing drug class reference signatures using tissue histomorphometry image input from at least one subject treated with a drug of known utility;
using the method of claim 1 to generate a test signature from a second subject in response to treatment with a therapeutic agent of unidentified utility;
processing the drug class reference signatures and the test signatures;
comparing the test signature to the drug class reference signatures by overlaying the test signature and the corresponding drug class reference signature;
determining whether the test signature elicits a change or response comparable to the drug class reference signatures, wherein a similarity is indicative of a drug in the same class as that used to generate the drug class reference signatures; and
identifying a therapeutic molecule based upon the similarity.

20. A database comprising a collection of signatures generated according to the methods of any one of claims 15-17.
